(19) United States
(12) Patent Application Publication
(10) Pub. No.: US 2005/0259320 A1
(43) Pub. Date: Nov. 24, 2005

(54) Microscope

(75) Inventor: Kaori Fujimura, Asaka-shi (JP)

Correspondence Address: Scully, Scott, Murphy & Presser, 400 Garden City Plaza, Garden City, NY, 11530-3319, US

(73) Assignee: Olympus Corporation, Tokyo (JP)

(21) Appl. No.: 11/081,948

(22) Filed: Mar. 16, 2005

(30) Foreign Application Priority Data
Mar. 19, 2004 (JP) 2004-081536
Jan. 21, 2005 (JP) 2005-014293

(51) Int. Cl. G02B 21/06

(52) U.S. Cl. 359/385

(57) ABSTRACT

A light projection unit is accommodated in a light projection unit accommodating portion from an opening portion formed to a microscope main body, and a light guide or the like is attached to the accommodated light projection unit through the opening portion formed to the microscope main body.

### CROSS-REFERENCE TO RELATED APPLICATIONS

This application is based upon and claims the benefit of priority from prior Japanese Patent Applications No. 2004-081536, filed Mar. 19, 2004; and No. 2005-014293, filed Jan. 21, 2005, the entire contents of both of which are incorporated herein by reference.

### BACKGROUND OF THE INVENTION

1. Field of the Invention

The present invention relates to a microscope comprising a light projection unit which can be detachably accommodated in a microscope main body.

2. Description of the Related Art

In recent years, microscopes are used for various kinds of examinations. For example, in a microscope, a large sample such as a wafer is mounted on an upper surface of a stage, and an arbitrary point on a sample surface is examined while moving the stage. It is known that a sample having a high light transmission factor among samples is examined based on a backlight observation.

In recent manufacture of semiconductor elements, the productivity is improved by using a large wafer in order to manufacture many chip ICs and the like from one wafer. It can be readily expected that an increase in size of a wafer advances in future in order to manufacture many chip ICs and the like with a low cost.

A wafer manufactured in a semiconductor element manufacturing process is subjected to various kinds of examinations in order to examine, e.g., scratches, adhesion of dust and others by using a microscope. In these examinations, a wafer as a sample is mounted on a stage upper surface, and an arbitrary point of the wafer is observed while freely moving the stage.

A microscope used for such an examination is assembled in an examination device as a part of this examination device. This examination device automatically carries a wafer or the like onto an upper surface of a stage attached to a microscope main body in order to smoothly perform an examination, and is often used in a semiconductor element examination process.

In a stage on which a wafer is mounted, it is often the case that a lever which is used to operate the stage in front/back/right/left directions from a user side toward a stage side is provided on the right side of a user for the user's convenience. Therefore, a carriage device which carries a wafer is often provided on a left side surface of the examination device so that operations of the stage by a user cannot be prevented.

On the other hand, with a spread of home electric appliances utilizing a flat pane display (FPD), manufacture of a liquid crystal display (LCD) which is one kind of FPD is drastically increasing. In an LCD examination in an LCD manufacturing process, it is general to observe an LCD through transmitted illumination. As to this LCD examination, an application for the transmitted illumination observation is assuredly increasing. In order to perform such an observation based on the transmitted illumination, it is often the case that a dedicated microscope main body is required.

As a microscope which irradiates a sample with a transmitted illumination light, there is one in which a transmitted illumination unit which performs transmitted illumination is previously provided to a microscope main body. On the other hand, for example, Jpn. Pat. Appln. KOKAI Publication No. 2001-33706 discloses a microscope in which a transmitted illumination unit is retrofitted.

Jpn. Pat. Appln. KOKAI Publication No. 2001-33706 discloses a microscope in which a transmitted illumination unit which performs transmitted illumination with respect to a sample is detachably attached on a side surface of a microscope main body. In this microscope, a first attachment fitting hole is provided on a side surface of the microscope main body, and a transmitted illumination light projection device which performs transmitted illumination with respect to a sample is attached to/removed from this attachment fitting hole.

This transmitted illumination light projection device comprises: an adapter frame which positions and holds a fiber light source (an optical fiber) which leads a transmitted illumination light from the outside and also retains each optical element; an field stop device for an illumination system; a deflecting mirror which deflects a transmitted illumination light exiting from a light guide in an optical axis direction of an objective lens; and a frame which holds each optical element. To the transmitted illumination light projection device are provided a lever for the field stop device, a centering knob, an insertion portion into which the light guide is inserted and others.

FIG. 31 is a block diagram showing a microscope disclosed in Jpn. Pat. Appln. KOKAI Publication No. 2001-33706. An reflected illumination device 401 is provided to a microscope main body 400. To the microscope main body 400 are provided a stage 402, a stage attachment member 403 having a built-in transmitted illumination optical system which is used to attach the stage 402, and a focus adjust devise 404. It is to be noted that a stage attachment member 405 for reflected illumination is prepared.

A first attachment fitting hole 406 is formed on a side surface of the microscope main body 400. A transmitted illumination light projection device 407 which performs transmitted illumination with respect to a sample mounted on the stage 402 can be attached to/removed from the first attachment fitting hole 406. The first attachment fitting hole 406 is provided on a surface orthogonal to an observation optical axis P of the microscope main body 400.

The transmitted illumination light projection device 407 comprises a cylindrical frame 409 which has an optical element 408 provided at an end portion thereof and a non-illustrated optical fiber attached to a base portion thereof, and a fitting shaft 410 provided on an outer peripheral surface of the frame 409 at a substantially middle position in the longitudinal direction. The transmitted illumination light projection device 407 is attached to the microscope main body 400 by inserting the frame 409 into the first attachment fitting hole 406 and fastening the fitting shaft 410 by using each screw 411.

In case of such a microscope, the transmitted illumination light projection device 407 is attached into the first attachment fitting hole 406 and the stage attachment member 403 having the built-in transmitted illumination optical system is disposed when a sample is subjected to the transmitted illumination observation. As a result, transmitted illumination can be realized without requiring a microscope main body dedicated to transmitted illumination. That is, it is possible to deal with transmitted illumination by retrofitting the transmitted illumination light projection device 407, and a transmitted illumination microscope apparatus does not have to be newly provided. This microscope is advantageously configured in terms of cost.

### BRIEF SUMMARY OF THE INVENTION

According to a main aspect of the present invention, there is provided a microscope comprising: an observation optical system which observe a image of a sample; a microscope main body which has at least the observation optical system and has a stage on which the sample is mounted; a light source which is provided outside the microscope main body and emits a light beam; a light guide which transmits the light beam emitted from the light source; a light projection unit which projects the light beam transmitted by the light guide; a condenser lens unit which leads the light beam projected by the light projection unit to the sample mounted on an optical axis of the observation optical system; and a light projection unit accommodating portion which has an opening portion provided to the microscope main body and detachably accommodates the light projection unit in the microscope main body through the opening portion.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a partial cross-sectional view showing a first embodiment of a microscope according to the present invention from a side surface;

FIG. 2 is a partial cross-sectional view of a base portion side surface in the microscope depicted in FIG. 1;

FIG. 3 is a top view of a stage attachment portion in the microscope depicted in FIG. 1;

FIG. 4 is a cross-sectional view of a base portion front surface in the microscope depicted in FIG. 1;

FIG. 5 is a block diagram of a middle frame in the microscope depicted in FIG. 1;

FIG. 6 is a cross-sectional view of a light projection unit, a condenser lens unit and a stage attachment member in a second embodiment of the microscope according to the present invention;

FIG. 7 is a partial cross-sectional view showing the light projection unit of the microscope of FIG. 6 from above;

FIG. 8 is a block diagram showing a fixing portion of a dovetail mechanism in the microscope depicted in FIG. 6;

FIG. 9 is a cross-sectional view of a light projection unit, a condenser lens unit and a stage attachment member in a third embodiment of the microscope according to the present invention;

FIG. 10 is a partial cross-sectional view showing the light projection unit in the microscope of FIG. 9 from above;

FIG. 11 is a view showing a part of a deflection optical system in the microscope depicted in FIG. 9;

FIG. 12 is a block diagram showing a fourth embodiment of the microscope according to the present invention;

FIG. 13 is a cross-sectional view showing a light guide accommodation portion in the microscope depicted in FIG. 12;

FIG. 14 is a block diagram showing a fifth embodiment of the microscope according to the present invention;

FIG. 15 is a partial cross-sectional view showing an inside of a lower portion of a microscope main body in the microscope of FIG. 14 from a right side;

FIG. 16 is a top view partially showing a cross section of a transmitted illumination unit in the microscope depicted in FIG. 14;

FIG. 17 is a side view partially showing the cross section of the transmitted illumination unit in the microscope depicted in FIG. 14;

FIG. 18 is a block diagram showing a light guide fixing mechanism in the microscope depicted in FIG. 14;

FIG. 19 a front block diagram of an aperture diaphragm device in the microscope depicted in FIG. 14;

FIG. 20 is a side block diagram of the aperture diaphragm device in the microscope depicted in FIG. 14;

FIG. 21 is a block diagram showing a transmitted illumination unit in a sixth embodiment of the microscope according to the present invention;

FIG. 22 is a block diagram of rotation support of a rotation frame with respect to a rotation support hole in the microscope depicted in FIG. 21;

FIG. 23 is a view showing rotation restriction of the rotation frame by each rotation restricting surface in the microscope depicted in FIG. 21;

FIG. 24A is a block diagram showing an upper surface of a transmitted illumination unit in a seventh embodiment of the microscope according to the present invention;

FIG. 24B is a partial side view of the transmitted illumination unit in the microscope depicted in FIG. 24A;

FIG. 25A is a top view showing a sliding member at a part where the light guide is attached in the microscope depicted in FIG. 24A;

FIG. 25B is a side view showing a sliding member at a part where a light guide is attached in the microscope depicted in FIG. 24A;

FIG. 26A is a top view of a mirror holding portion in the microscope depicted in FIG. 24A;

FIG. 26B is a side view of the mirror holding portion in the microscope depicted in FIG. 24A;

FIG. 27A is a view showing attachment of the light guide to a right side surface in the microscope depicted in FIG. 24A;

FIG. 27B is a view showing attachment of the light guide to the right side surface in the microscope depicted in FIG. 24A;

FIG. 28 is a view showing attachment of the light guide to a left side surface in the microscope depicted in FIG. 24A;

FIG. 29 is a block diagram showing an aperture diaphragm device in the microscope depicted in FIG. 24A;

FIG. 30 is a view showing a structure which can twist a knob to right and left sides in the aperture diaphragm device in the microscope depicted in FIG. 24A; and

FIG. 31 is a block diagram of a conventional microscope.

### DETAILED DESCRIPTION OF THE INVENTION

A first embodiment according to the present invention will now be described hereinafter with reference to the accompanying drawings.

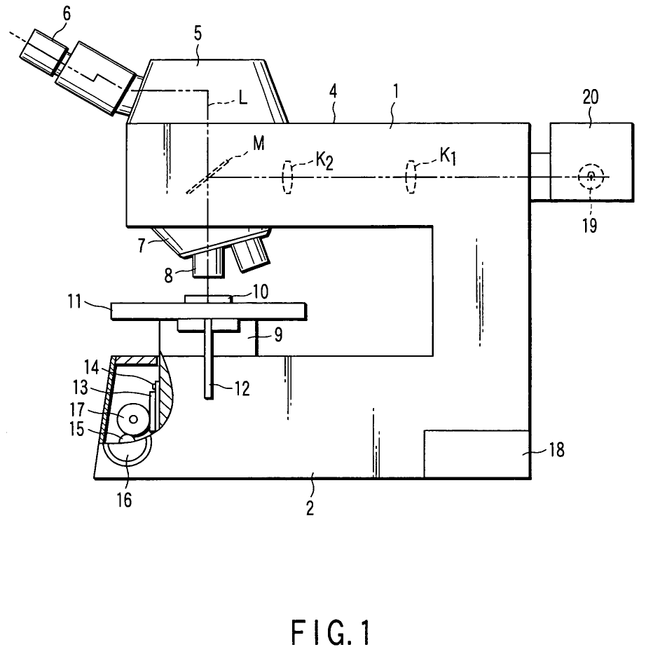

FIG. 1 is a partial cross-sectional view showing a microscope from a side surface. A microscope main body 1 is formed into a U-like shape, and has a base portion 2 and an arm portion 4. An ocular tube 5 is provided on an upper surface of the arm portion 4 along an observation optical axis L. An eye-piece lens 6 is disposed to the ocular tube 5. A revolver 7 is rotatably provided to a lower surface of the arm portion 4.

A plurality of object lens 8 having different magnifications are attached to the revolver 7. The revolver 7 rotates to arrange an object lens 8 having a desired magnification on the observation optical axis L.

A stage attachment member 9 is provided to the base portion 2. A stage 11 on which a sample 10 is mounted is provided on the stage attachment member 9. The stage 11 can be freely moved in front/back/right/left directions within a plane (an XY plane) orthogonal to a plane (a Z plane) including the observation optical axis L. A stage operation handle 12 having a rod-like shape is downwardly provided at an edge portion of the lower surface of the stage 11.

A rack 13 is fixed to a side surface of the stage attachment member 9 hidden in the base portion 2 by a screw 14. A shaft 15 formed of a pinion is rotatably provided to the base portion 2. Respective focusing handles 16 are provided to both end portions of the shaft 15. A gear 17 meshes with the shaft 15. The gear 17 is rotatably provided to the base portion 2. The gear 17 is provided in such a manner that it meshes with the rack 13.

Therefore, when the focusing handles 16 are rotated, rotation of the focusing handles 16 is transmitted to the rack 13 through the gear 17. The rack 13 converts the rotation of the gear 17 into upward and downward movements and transmits the converted movements to the stage attachment member 9. As a result, the stage 11 moves up and down. The upward and downward movements of the stage 11 adjust a distance between the sample 10 and the objective lens 8. Focusing with respect to the sample 10 is performed.

It is to be noted that the stage 11 can be freely moved in front/rear/right/left directions within the plane (the XY plane) orthogonal to the plane (the Z plane) including the observation optical axis L. A foot 18 which enhances the safety is provided on the rear surface side of the microscope main body 1 in such a manner that the foot 18 broadens in right and left directions as seen from the front side of the microscope main body 1.

On the other hand, an optical system of the microscope will now be described. An reflected illumination device 20 is assembled on the rear surface side of the microscope main body 1. The reflected illumination device 20 has a light source 19. Respective light projection lenses K₁ and K₂ and a half mirror M are provided on an optical path of an illumination light projected from the light source 19 of the reflected illumination device 20.

The half mirror M is arranged on the observation optical axis L. The half mirror M reflects an illumination light projected from the light source 19 of the reflected illumination device 20 toward the objective lens 8 side to subject the sample 10 to reflected illumination. The half mirror M transmits a light from the sample 10 which has passed through the objective lens 8 therethrough toward the ocular tube 5 side.

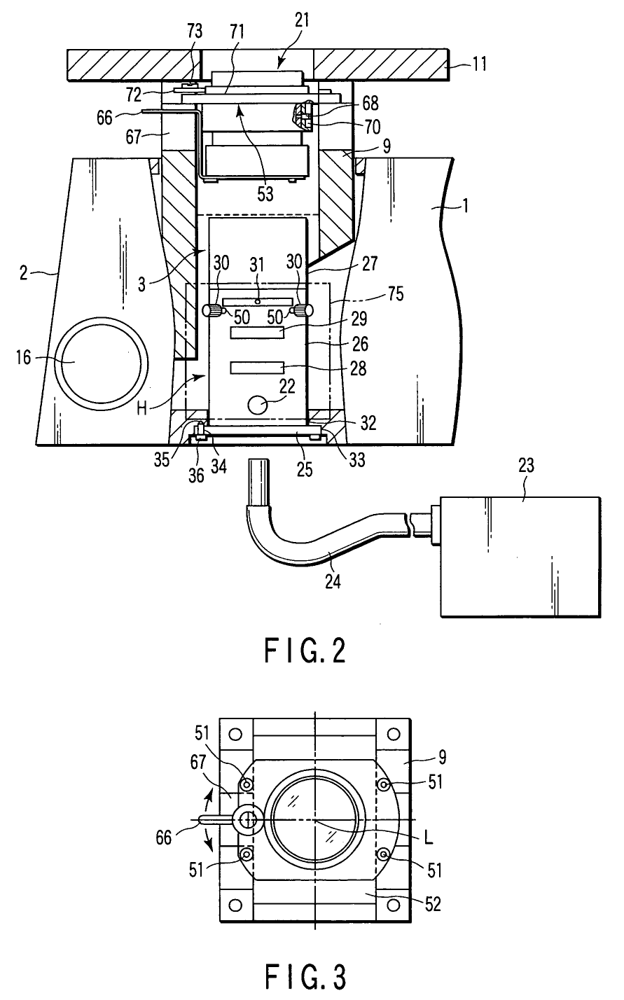

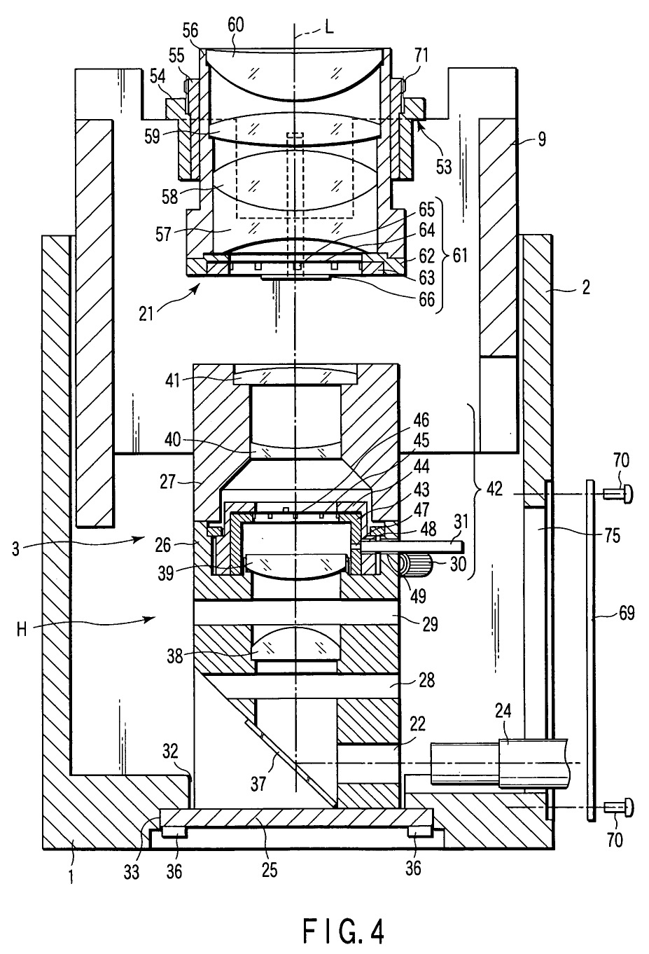

A characteristic part of the microscope according to the present invention will now be described. FIG. 2 shows a partial cross-sectional view of a base portion side surface. FIG. 3 shows a top view of a stage attachment portion. FIG. 4 shows a cross-sectional view of a base portion front surface.

A light projection unit 3 is provided to the base portion 2 of the microscope main body 1 on the observation optical axis L. A condenser lens unit 21 is provided in the stage attachment member 9.

A light guide attachment portion 22 is provided to the light projection unit 3. The light guide attachment portion 22 attaches and fixes a light guide 24 connected to a light source 23 for transmitted illumination by using a non-illustrated screw or the like. The light projection unit 3 leads a transmitted illumination light exiting from the light guide 24 to the condenser lens unit 21.

The light projection unit 3 has a fitting plate 25, a cylindrical lower frame body 26 provided on an upper surface of the fitting plate 25, and a cylindrical upper frame body 27 provided on a lower frame body 26. It is to be noted that the fitting plate 25 is provided with an axis of the optical system as the center in order to match the optical axis L with an axis of transmitted illumination.

The lower frame body 26 and the upper frame body 27 are coupled with each other by using a non-illustrated screw, adhesive or the like, and integrally constitute the light projection unit 3. On the side surface of the lower frame body 26 are provided respective slider insertion portions 28 and 29, knobs 30 and a lever 31 which will be described later and others as well as the light guide attachment portion 22. Various kinds of optical elements such as a polarizer or a filter are inserted into or removed from the respective slider insertion portions 28 and 29. It is to be noted that the respective slider insertion portions 28 and 29 are provided in a direction orthogonal to the observation optical axis L.

An opening portion 32 from which the light projection unit 3 is inserted into the base portion 2 is provided on the bottom surface of the base portion 2. A light projection unit accommodating portion H which is used to insert the light projection unit 3 is formed in the base portion 2 and the stage attachment portion 9 from the opening portion 32. It is to be noted that a fitting portion 33 is provided to the opening portion 32 with the optical axis L at the center.

The fitting portion 33 fits to the fitting plate 25 of the light projection unit 3. A size of the opening portion 32 is slightly larger than an outside diameter of the light projection unit 3, and this size enables insertion of the light projection unit 3.

A counterbored hole 34 is formed to the fitting plate 25 of the light projection unit 3. A screw portion 35 is formed to the base portion 2 at a position corresponding to the counterbored hole 34. A screw 36 is screwed to the screw portion 35 through the counterbored hole 34 of the fitting plate 25. As a result, the light projection unit 3 is fixed to the base portion 2. An optical axis of the light projection unit 3 is matched with the observation optical axis L.

As shown in FIG. 4, for example, a mirror 37 is arranged as a deflection element in the lower frame portion 26 of the light projection unit 3. If the observation optical axis L vertically crosses an optical path of a transmitted illumination light exiting from the light guide 24, the mirror 37 is arranged at an angle of 45° with respect to the observation optical axis L and the optical path of the transmitted illumination light. The mirror 37 reflects the transmitted illumination light exiting from the light guide 24 in such a manner that this light matches with the observation optical axis L. The mirror 37 is fixed to the lower frame body 26 by using, e.g., an adhesive or a non-illustrated leaf spring.

Respective optical elements 38 to 41 are provided on the observation optical axis L in the light projection unit 3. The respective optical elements 38 to 41 lead the transmitted illumination light reflected by the mirror 37 to the condenser lens unit 21. The respective optical elements 38 to 41 are held in the lower frame body 26 and the upper frame body 27 by using, e.g., an adhesive or a non-illustrated leaf spring.

A field stop device 42 is provided to an upper portion of the lower frame body 26. The field stop device 42 adjusts an aperture diameter on the observation optical axis L. The field stop device 42 comprises two blade holding frames 43 and 44. A plurality of blades 45 are held in the respective blade holding frames 43 and 44 by using a pin 46 or the like.

A screw portion 47 is provided to the blade holding frame 43 in order to attach the lever 31. The blade holding frame 43 adjusts an aperture diameter when rotating around the observation optical axis L. In this example, grooves 48 and 49 are respectively provided to the blade holding frame 44 and the lower frame body 26 so that the lever 31 can be freely rotated. The respective grooves 48 and 49 can adjust an aperture diameter of the field stop device 42 from the maximum level to the minimum level when the lever 31 is rotated around the observation optical axis L.

Screw portions 50 are provided to the lower frame body 26 as shown in FIG. 2. The knobs 30 are screwed into the screw portions 50. When the knobs 30 are screwed, the knobs 30 reach the blade holding frame 44. A non-illustrated plunger or the like is disposed to the lower frame body 26 in such a manner that the blade holding frame 44 is pushed from a position facing the knobs 30.

The lever 31 and the knobs 30 are detachably provided to the light projection unit 3.

The condenser lens unit 21 condenses a transmitted illumination light led from the light projection unit 3 to the sample 10. The condenser lens unit 21 is fixed to the stage attachment member 9 by screws 51 or the like as shown in FIG. 3. An insertion portion 52 is formed to the stage attachment member 9. The insertion portion 52 is provided so that the condenser lens unit 21 can be inserted to a contact surface 53 as shown in FIG. 4.

The condenser lens unit 21 has a cylindrical outer frame 54 fixed to the stage attachment member 9 by the screws 51 as shown in FIG. 3, a cylindrical middle frame 55 provided in contact with the inside of the outer frame 54, and a cylindrical frame body 56 provided in contact with the inside of the middle frame 55.

Respective optical elements 57 to 60 are held in the frame body 56 along the observation optical axis L. The respective optical elements 57 to 60 irradiate the sample 10 with a transmitted illumination light which has entered along the observation optical axis L. The respective optical elements 57 to 60 are held with respect to the frame body 56 by an adhesive, a non-illustrated leaf spring or the like, for example. It is to be noted that the respective optical elements 57 to 60 can move up and down together with the frame body 56 in the same direction as the observation optical axis L.

An aperture diaphragm device 61 is provided to the lower portion of the frame body 56. The aperture diaphragm device 61 adjusts an aperture diaphragm diameter on the observation optical axis L. The aperture diaphragm device 61 holds a plurality of aperture blades 64 with respect to two blade holding frames 62 and 63 by using pins 65 or the like.

A lever 66 is rotatably provided to the blade holding frame 63. The lever 66 rotates about the observation optical axis L to adjust an aperture diameter. The lever 66 has a bent shape, and protrudes toward the outside from an opening portion 67 formed on the side surface of the stage attachment member 9 as shown in FIGS. 2 and 3.

An opening width of the opening portion 67 is formed as a width with which an aperture diameter of the aperture diaphragm device 61 can be adjusted from the maximum level to the minimum level when the lever 66 is rotated around the observation optical axis L.

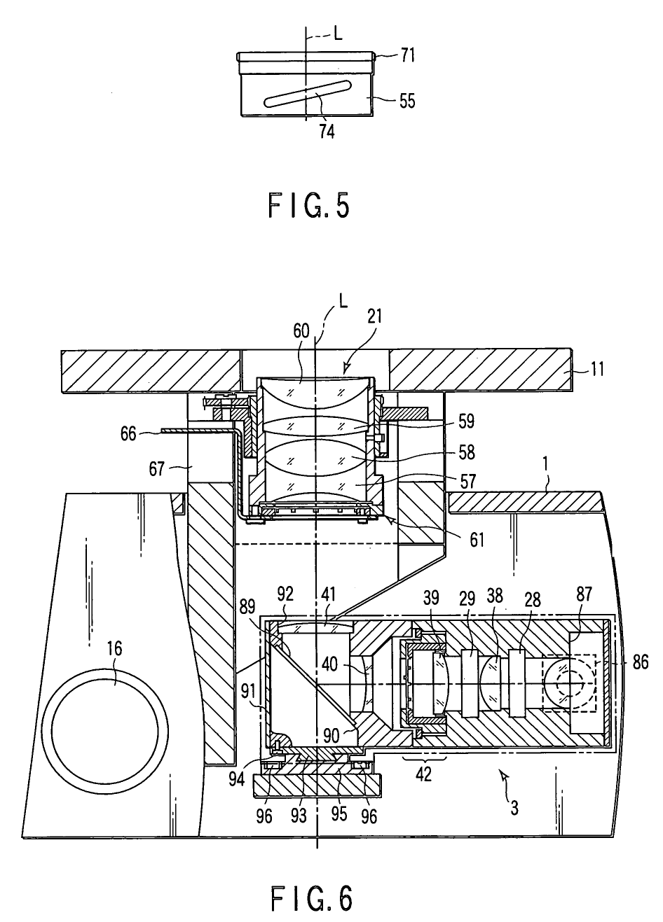

As shown in FIG. 2, a pin 68 is erectly provided on the side surface of the frame body 56. A cam groove 74 is formed to the middle frame 55 as shown in FIG. 5. The cam groove 74 is inclined in the direction of the observation optical axis L. A pin 68 fits in the cam groove 74 and slides in the cam groove 74.

A groove 70 is provided to the outer frame 54. The groove 70 guides the pin 68 to move in the direction of the observation optical axis L, and restricts a movement range of the pin 68.

A gear 71 is formed to the upper portion of the middle frame 55. A gear 72 meshes with the gear 71. As shown in FIG. 2, the gear 72 is held with respect to the outer frame 54 in such a manner that it can freely rotate by a shaft 73. Since the middle frame 55 is rotatably held with respect to the outer frame 54, the gear 72 can be manually operated through the opening portion 67 of the stage attachment member 9.

It is to be noted that the method of moving up and down the respective optical elements 57 to 60 is not restricted to a use of a cam mechanism and a method utilizing a rack and a pinion may be adopted.

As shown in FIGS. 2 and 4, for example, a square opening portion 75 is provided to the side surface of the base portion 2. For example, a lid 69 can be attached to or removed from the opening portion 75 by using each screw 70. The opening portion 75 is provided at a position where the respective slider insertion portions 28 and 29, the knobs 30, the lever 31 and the light guide attachment member 22 in the light projection unit 3 can be seen.

Insertion or removal of sliders provided with various kinds of optical elements, e.g., a polarizer or a filter with respect to the slider insertion portions 28 and 29, operations of the knobs 30 or the lever 31, and attachment and removal operations of the light guide 24 with respect to the light guide attachment portion 22 are enabled through the opening portion 75.

An effect of the microscope having the above-described configuration will now be explained.

The lever 31 and each knob 30 are removed from the light projection unit 3 in advance. As a result, the light projection unit 3 can be inserted into the light projection unit accommodating portion H from the opening portion 32 formed on the bottom surface of the base portion 2 of the microscope apparatus.

The light projection unit 3 is inserted into the light projection unit accommodating portion H from the opening portion 32, and the fitting plate 25 is fitted to the fitting portion 33. The fitting plate 25 is fixed to the bottom surface of the base portion 2 by each screw 36. As a result, the light projection unit 3 is provided in such a manner that an optical axis of the respective optical elements 38 to 41 matches with the observation optical axis L.

Then, the lid 69 on the side surface of the microscope main body 1 is removed. The opening portion 75 is opened. As a result, the respective slider insertion portions 28 and 29, the knobs 30, the lever 31 and the light guide attachment portion 22 in the light projection unit 3 can be seen through the opening portion 75. In this state, the lever 31 is attached to the respective blade holding frames 43 and 44 with respect to the light projection unit 3. Concurrently, each knob 30 is disposed to the lower frame body 26.

The light guide 24 is set to the light source 23. The light guide 24 is fixed to the light guide attachment portion 22 by using non-illustrated screws or the like. It is to be noted that an opening may be provided to the lid 69 so that the slider insertion portions 28 and 29, the knobs 30, the lever 31 and the light guide attachment portion 22 can be seen without removing the lid 69.

Since the light projection unit 3 is accommodated in the microscope main body 1 in this manner, it does not protrude from an exterior surface of the microscope main body 1.

The condenser lens unit 21 can be inserted into the insertion portion 67 of the stage attachment member 9 shown in FIG. 3 by removing the stage 11. The condenser lens unit 21 can be attached to and removed from the stage attachment member 9 by using the screws 51. Since the condenser lens unit 21 is also held in the stage attachment member 9, it does not protrude from the microscope main body 1.

A transmitted illumination light projected from the light source 23 is transmitted in the light guide 24 to be led to the light projection unit 3. When the transmitted illumination light exits from the light guide 24, it is reflected upward by the mirror 37 and travels along the observation optical axis L to be led to the respective optical elements 38 and 39, the field stop device 42 and the respective optical elements 40 and 41.

At this time, when the knobs 30 provided to the lower frame body 26 are rotated in the clockwise direction or the counterclockwise direction, the blade holding frame 44 in the field stop device 42 moves with respect to the lower frame body 26 in a plane vertical to the observation optical axis L. As a result, centering of the field stop device 42 is carried out.

When the lever 31 is rotated about the observation optical axis L, the aperture blades 45 of the field stop device 42 are opened or closed. As a result, it is possible to perform an adjustment to obtain an aperture diameter suitable for observation.

The transmitted illumination light transmitted through the light projection unit 3 is led to the aperture diaphragm device 61 and the respective optical elements 57 to 60 of the condenser lens unit 21. In the aperture diaphragm device 61, like the light projection unit 3, when the lever 66 is rotated around the observation optical axis L, the aperture blades 64 are opened or closed. Consequently, it is possible to perform an adjustment to obtain an aperture diameter suitable for observation.

When the gear 72 shown in FIG. 2 is rotated, the gear 71 of the middle frame 55 is rotated with the rotation of the gear 72, and the middle frame 55 is also rotated. When the middle frame 55 is rotated, the pin 68 slides along the inside of the cam groove 74 of the middle frame 55. Since the pin 68 is restricted by the groove 70 provided to the outer frame 54 from rotating, the frame body 56 moves up and down along the observation optical axis L. As a result, the respective optical elements 57 to 60 of the condenser lens unit 21 move up and down along the observation optical axis L.

A slider holding, e.g., a slider or a polarizer can be inserted into or removed from the respective slider insertion portions 28 and 29 provided to the lower frame body 26 of the light projection unit 3 in accordance with an application in observation.

As described above, according to the first embodiment, the light projection unit 3 is accommodated in the light projection unit accommodating portion H of the microscope main body 1 from the opening portion 32 formed on the bottom surface of the microscope main body 1, and the lever 31, each knob 30 or the light guide 24 is attached to the accommodated light projection unit 3 from the opening portion 75 formed on the side surface of the microscope main body 1. Consequently, the light projection unit 3 can be accommodated in the microscope main body 1 without protruding from the exterior surface of the microscope main body 1.

The condenser lens unit 21 can be attached to and removed from the stage attachment member 9 by holding the condenser lens unit 21 in the stage attachment member 9 and removing the stage 11. As a result, the condenser lens unit 21 likewise does not protrude from the microscope main body 1.

The light projection unit 3 and the condenser lens unit 21 do not protrude from the microscope main body 1. In observation of the sample 10, the stage operation handle 12 provided to the lower portion of the stage 11 can be operated without obstructions. The stage 11 can be smoothly moved in the front/rear/right/left directions in the same plane.

The light projection unit 3 is accommodated in the microscope main body 1 and closed by the lid 69. Consequently, dust, dirt or the like hardly adheres, and contamination control properties can be improved. This results in protection of the optical system from an external impact shock or the like. Since the light projection unit 3 can be attached to and removed from the microscope main body 1, it is also superior in the maintainability.

A second embodiment according to the present invention will now be described. It is to be noted that like reference numerals denote parts equal to those in FIGS. 1 to 5, thereby eliminating the detailed explanation thereof.

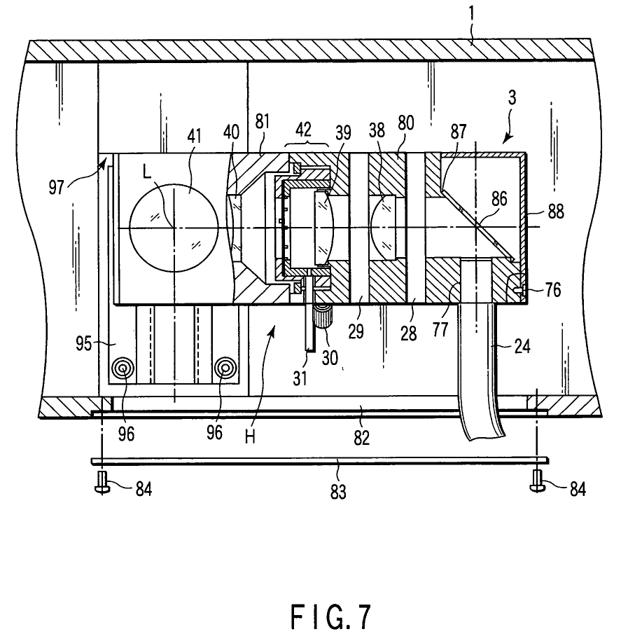

FIGS. 6 and 7 show block diagrams of a microscope apparatus. FIG. 6 is a cross-sectional view of a light projection unit 3, a condenser lens unit 21 and a stage attachment member 9. FIG. 7 is a partial cross-sectional view showing the light projection unit 3 from above.

In the microscope apparatus, the light projection unit 3 can be attached to and removed from the microscope main body 1 from the side surface. The light projection unit 3 comprises two frame bodies 80 and 81. The respective frame bodies 80 and 81 are coupled with each other by an adhesive or non-illustrated screws and integrally constituted.

An opening portion 82 is provided to the side surface of the microscope main body 1. The opening portion 82 is formed into a square shape by which the light projection unit 3 can be inserted into the microscope main body 1. The opening portion 82 is formed to have a width slightly longer than a length of the light projection unit 3 in the long distance direction and a height slightly longer than a length of the light projection unit 3 in the short distance direction. A lid 83 is fixed to the opening portion 82 by screws 84.

A light guide attachment portion 77 is provided to the frame body 80. A light guide 24 is provided to the light guide attachment portion 77. A mirror 86 is provided on an optical path of a transmitted illumination light exiting from the light guide 24.

The mirror 86 deflects the transmitted illumination light exiting from the light guide 24 in a perpendicular direction. The mirror 86 is fixed to a fixing surface 87 provided to the frame body 80 by an adhesive, a non-illustrate leaf spring or the like. The fixing surface 87 is vertical with respect to a surface including the transmitted illumination light which falls on the mirror 86 and a reflected light from the mirror 86, and forms an angle of 45 degrees with both the incident transmitted illumination light and the reflected light. A cover 88 which is an L-shaped sheet metal is fixed to the frame body 80 on the rear surface of the mirror 86 by a screw 76 or the like.

On the other hand, a mirror 89 is provided on a reflection optical path of the mirror 86 at a position distanced from the mirror 86 through respective optical elements 38 to 40. The mirror 89 is fixed to a fixing surface 90 formed to the frame body 81 by, e.g., an adhesive or a non-illustrated leaf spring.

The fixing surface 90 is vertical with respect to a surface including the transmitted illumination light which falls on the mirror 89 and a reflected light from the mirror 89, and forms an angle of 45° with both the incident transmitted illumination light and the reflected light. A cover 91 as a sheet metal is fixed to the frame body 81 on the rear surface of the mirror 89 by a non-illustrated screw or the like.

The transmitted illumination light deflected by the mirror 89 advances on the observation optical axis L. An optical element 41 is provided on an optical path of the transmitted illumination light deflected by the mirror 89, i.e., the observation optical axis L.

The optical element 41 is fixed to an attachment portion 92 provided to the frame body 81 by an adhesive or the like. It is to be noted that the mirror 89 is arranged between the respective optical elements 40 and 41 but it may be arranged at any position as long as an optical performance problem does not occur.

A dovetail portion 93 as a sliding member is disposed to the bottom surface of the light projection unit 3 by a screw 94. A dovetail portion 95 as a slide reception portion is fixed to the microscope main body 1 by screws 96.

A contact surface 97 is provided on a side facing the opening portion 82 on a straight line extending from the dovetail portion 95 as shown in FIG. 7. The contact surface 97 is a surface which is vertical with respect to the direction of the dovetail portion 95. The contact surface 97 positions the light projection unit 3 in such a manner that an optical axis of a light ray deflected by the mirror 89 of the light projection unit 3 matches with the observation optical axis L.

As a result, when the light projection unit 3 is inserted into the microscope main body 1 from the opening portion 82, the dovetail portion 93 is inserted into the dovetail portion 95 and the dovetail portion 93 is pushed along the dovetail portion 95, the light projection unit 3 comes into contact with the contact surface 97. Consequently, an optical axis of the light projection unit 3 matches with the observation optical axis L, and the light projection unit 3 is positioned.

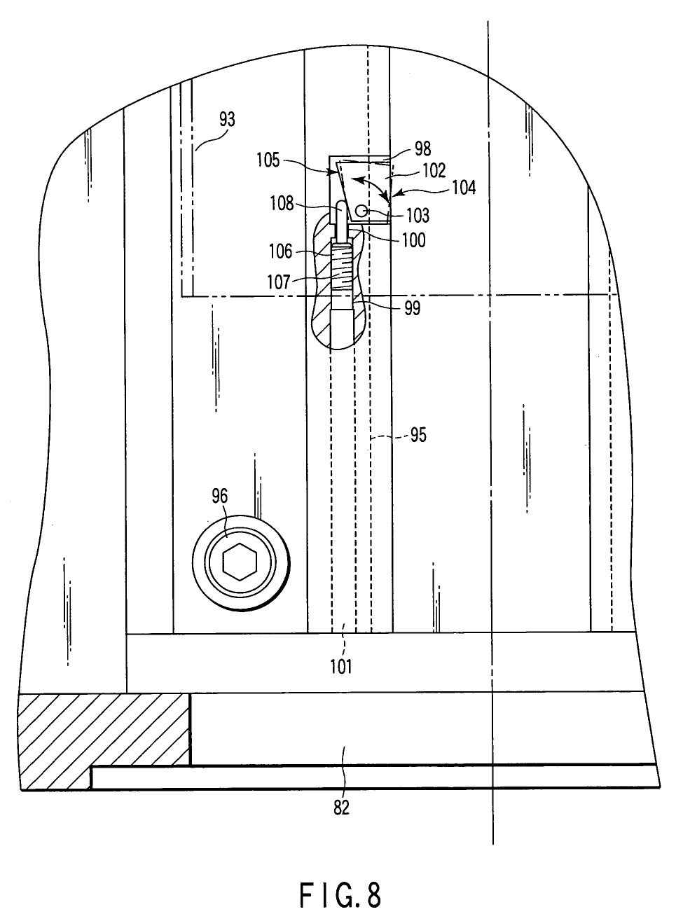

As shown in FIG. 8, an opening portion 98, a screw portion 99, a hole 100 and a tool insertion portion 101 are provided on the dovetail portion 95. The opening portion 98 constitutes a holding portion which holds the light projection unit 3.

A piece 102 which fixes the dovetail portion 93 and the dovetail portion 95 is provided in the opening portion 98 above the dovetail portion 95 in such a manner that the piece 102 can rotate around a pin 103. The piece 102 has a pressing surface 104 and a tapered portion 105. The pressing surface 104 is formed at the same angle as the dovetail portion 95. It is to be noted that the opening portion 98 is provided in such a manner that the piece 102 is placed on the side surface of the dovetail portion 93 when the dovetail portion 93 is brought into contact with a contact portion 97 of the microscope main body 1.

A stepped screw 107 having a screw portion 106 is screwed. The stepped screw 107 can be screwed by using a tool which is inserted from the outside. The stepped screw 107 comprises an end portion 108 and the screw portion 106. The end portion 108 can move in the hole 100.

The tool insertion portion 101 is formed in the dovetail portion 95 in a direction along which the dovetail portion 95 is formed. The tool insertion portion 101 is provided in such a manner that the stepped screw 107 and a tool which is used to screw the stepped screw 107 can be inserted from the lateral surface side of the microscope main body 1.

The tapered portion 105 is provided in such a manner that the tapered portion 105 of the piece 102 is pushed and the piece 102 can rotate around the pin 103 when the stepped screw 107 is screwed. When the stepped screw 107 is screwed, the piece 102 rotates as indicated by broken lines in the drawing, for example.

An effect of the microscope apparatus having the above-described configuration will now be explained.

When the screws 84 fixing the lid 83 provided on the side surface of the microscope main body 1 are removed, the opening portion 82 is opened. In this state, the light projection unit 3 is inserted into the microscope main body 1 from the opening portion 82. The dovetail portion 93 of the light projection unit 3 is inserted into the dovetail portion 95 provided to the microscope main body 1. Then, the light projection unit 3 is pushed along the dovetail portion 95. As a result, the light projection unit 3 comes into contact with the contact surface 97. Consequently, the optical axis of the light projection unit 3 matches with the observation optical axis L, and the light projection unit 3 is positioned.

Then, as shown in FIG. 8, a non-illustrated tool is inserted from the lateral surface side of the microscope main body 1 through the tool insertion portion 101. The stepped screw 107 is screwed by using this tool. An end of the screwed stepped screw 107 pushes the tapered portion 105 of the piece 102. At this time, the piece 102 is placed on the side surface of the dovetail portion 93, and the pushed piece 102 tries to rotate around the pin 103 in the direction of the dovetail portion 93. As a result, the piece 102 presses the dovetail portion 93 against the dovetail portion 95, and the light projection optical system 3 is fixed to the microscope main body 1.

It is to be noted that the stepped screw 107 is formed with a stepped shape. Consequently, the stepped screw 107 can be prevented from falling into the microscope main body 1 even when the stepped screw 107 is screwed too much when the dovetail portion 93 is not inserted.

When the light projection unit 3 is inserted to reach the contact surface 97 and fixed to the microscope main body 1 by the stepped screw 107 in this manner, a transmitted illumination light which is reflected upward by the mirror 98 and led by the optical element 41 matches with the observation optical axis L. As a result, the transmitted illumination light is led to the condenser lens unit 21.

When removing the light projection unit 3, the stepped screw 107 fixed to the microscope main body 1 is loosened and pulled out while holding the knobs 30 and the like.

The light guide 24 is disposed to the light guide attachment portion 77. A transmitted illumination light exiting from the light guide 24 is deflected by the mirror 86, transmitted through the respective optical elements 38 and 39 and the field stop device 40 and falls on the mirror 89.

The transmitted illumination light is upwardly deflected by the mirror 89 and enters the optical element 41. Then, the transmitted illumination light transmitted through the light projection unit 3 enters the condenser lens unit 21.

As described above, according to the second embodiment, the light projection unit 3 is accommodated in the microscope main body 1 from the opening portion 82 formed on the side surface of the microscope main body 1. As a result, like the first embodiment, the stage operation handle 12 provided below the stage 11 can be operated without obstacles and the stage 11 can be smoothly moved in the front/rear/right/left directions in the same plane in observation of the sample 10.

It is not necessary to turn over the microscope main body 1 or attach/remove the light projection unit 3 in a lifted state, and hence this embodiment is superior to the first embodiment in the attachment/detachment properties.

Further, when attaching the light projection unit 3, the lever 31 or the knobs 30 of the field stop device 42 do not have to be removed. The attachment/detachment operation is not complicated, the usability is good and the maintenance is excellent.

Since the respective covers 88 and 91 are provided, the respective mirrors 86 and 89 can be protected.

A third embodiment according to the present invention will now be described. Like reference numerals denote parts equal to those in FIGS. 1 to 8, thereby eliminating the detailed explanation.

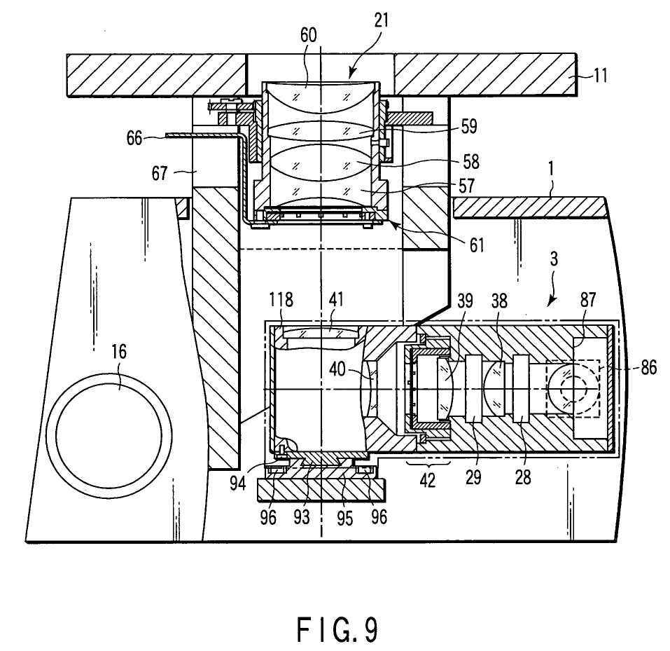

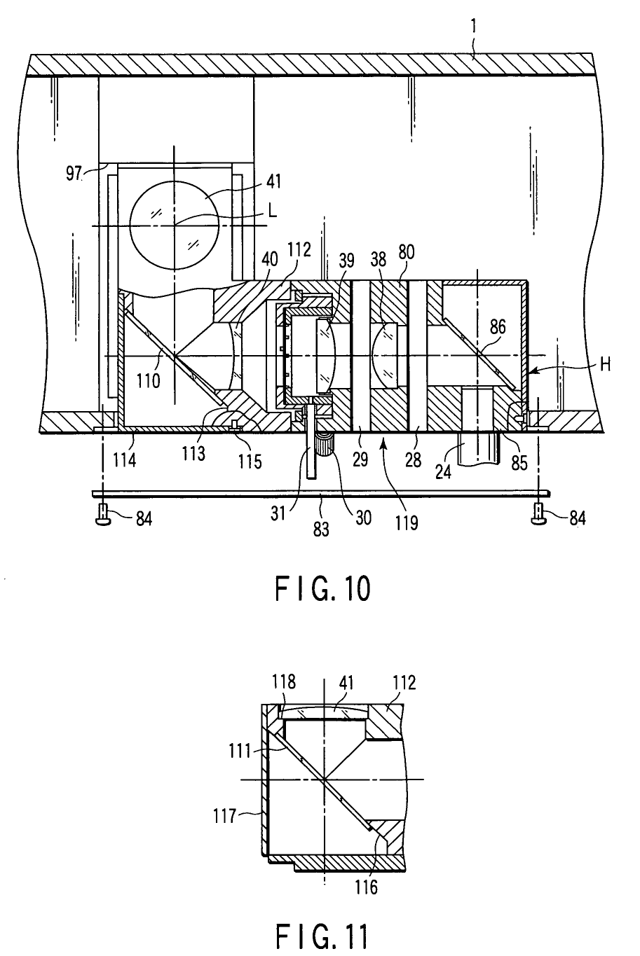

FIGS. 9 and 10 show block diagrams of a microscope. FIG. 9 shows a cross-sectional view of a light projection unit 3, a condenser lens unit 21 and a stage attachment member 9. FIG. 10 is a partial cross-sectional view showing the light projection unit 3 from above, and FIG. 11 is a view showing a part of a deflection optical system 3.

This microscope has a deflection optical system comprising respective mirrors 86, 110 and 111.

A light projection unit 3 comprises two frame bodies 80 and 112. The frame body 112 is formed into an L shape which is substantially perpendicularly bent. The respective frame bodies 80 and 112 are coupled with each other by an adhesive, non-illustrated screws or the like and integrally constituted.

A transmitted illumination light exiting from a light guide 24 is deflected by the mirror 86 in a perpendicular direction. The deflected transmitted illumination light is transmitted through respective optical elements 38 to 40 and falls on the mirror 110. The mirror 110 is provided in the frame body 112. A plane including the transmitted illumination light which falls on the mirror 110 and a reflected light from the mirror 110 is provided to be vertical with respect to the observation optical axis L.

A fixing surface 113 is provided to the frame body 112. The fixing surface 113 fixes the mirror 110 by an adhesive, a non-illustrated leaf spring or the like. A cover 114 which is an L-shaped sheet metal is fixed to the frame body 112 by a screw 115 on a rear surface of the mirror 110. The mirror 111 is provided on an optical path of the transmitted illumination light deflected by the mirror 110 as shown in FIG. 11.

The mirror 111 is provided in the frame body 112 of the light projection unit 3 in such a manner that the mirror 111 matches with the observation optical axis L. The mirror 111 is fixed to a fixing surface 116 of the frame body 112 by an adhesive, a non-illustrate leaf spring or the like. A cover 117 as a sheet metal is fixed to the frame body 112 by a non-illustrated screw or the like on a rear surface of the mirror 111.

An attachment portion 118 to which an optical element 41 is attached is provided to the frame body 112. The optical element 41 is fixed to the attachment portion 118 by an adhesive or the like.

It is to be noted that the mirror 110 and the mirror 111 are provided with a distance by which an operation portion end surface 119 of the light projection unit 3 becomes substantially in plane with the side surface of the microscope main body 1.

In this example, although the mirror 110 is arranged between the optical elements 40 and 41, it may be arranged at any position as long as there is no problem in optical performances.

An effect of the microscope having the above-described configuration will now be explained.

First, the screws 84 are removed, and the lid 83 provided on the side surface of the microscope main body 1 is removed. As a result, the opening portion 82 is opened. In this state, the light projection unit 3 is inserted into the microscope main body 1 from the opening portion 82.

The light projection unit 3 inserts a dovetail portion 93 into a dovetail portion 95 provided to the microscope main body 1. When the light projection unit 3 is pushed along the dovetail portion 95, the light projection unit 3 comes into contact with a contact surface 97. Consequently, the optical axis of the light projection unit 3 matches with the observation optical axis L, and the light projection unit 3 is positioned.

At this time, respective slider insertion portions 28 and 29, knobs 30 or a lever 31 provided to the light projection unit 3 are arranged at a position where they are exposed from the opening portion 82. A light guide attachment portion 85 is arranged in the vicinity of an opening of the opening portion 82.

A light guide 24 is disposed to the light guide attachment portion 85.

A transmitted illumination light exiting from the light guide 24 is deflected by the mirror 86, transmitted through the respective optical elements 38 and 39, a field stop device 42 and an optical element 40 and falls on the mirror 110.

The transmitted illumination light is deflected by the mirror 110, further deflected upward by the mirror 111 and enters an optical element 41. Furthermore, the transmitted illumination light transmitted through the light projection unit 3 enters a condenser lens unit 21.

As described above, according to the third embodiment, the deflection optical system comprising the respective mirrors 86, 110 and 111 is provided to the light projection unit 3. As a result, the position at which the respective slider insertion portions 28 and 29, the knobs 30 or the lever 31 provided to the light projection unit 3 are exposed and the light guide attachment portion 85 can be arranged in the vicinity of the opening of the opening portion 82.

Therefore, an operation of the lever 31 of the field stop device 42 exposed from the opening portion 82, an adjustment of the knobs 30, insertion/removal of sliders to/from the respective slider insertion portions 28 and 29 through the opening portion 82, insertion/removal of the light guide 24 corresponding to the light guide attachment portion 85, and others can be facilitated. Consequently, the operability and the visibility of the light projection unit 3 can be improved. The operation by an operator can be facilitated, and the usability is good.

Dust or dirt hardly adheres when an opening of the microscope main body side surface is minimized. It is possible to realize the microscope which is superior in contamination control properties.

A fourth embodiment according to the present invention will now be described. Like reference numerals denote parts equal to those in FIGS. 1 to 11, thereby eliminating the detailed explanation.

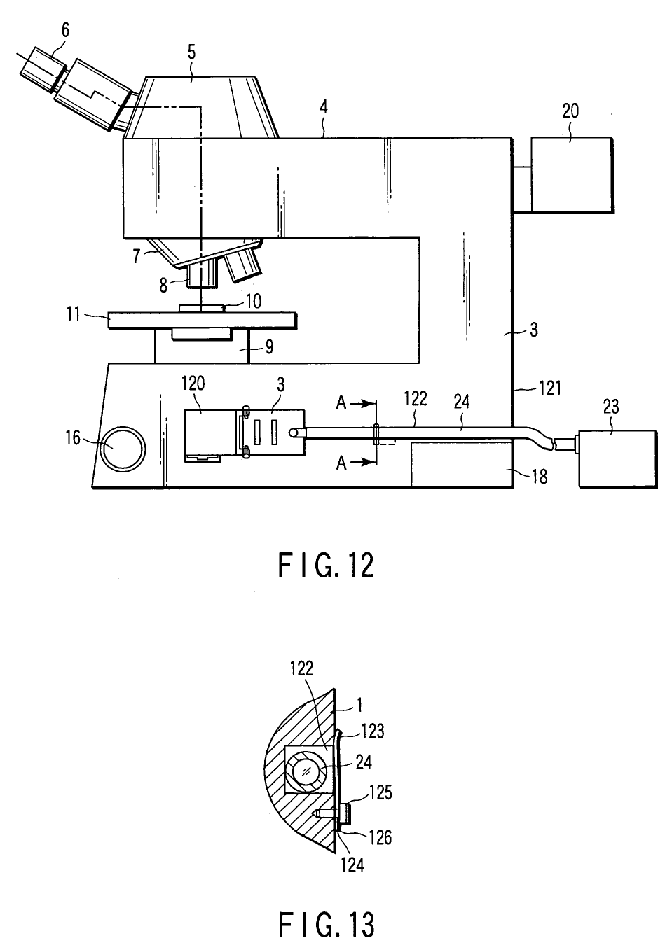

FIG. 12 shows a block diagram of a microscope main body. An opening portion 120 is provided on a side surface of the microscope main body 1. The opening portion 120 is formed into a square shape by which a light projection unit 3 can be inserted into the microscope main body 1. The opening portion 120 has a width formed to be slightly longer than a length of the light projection unit 3 in a long distance direction and a height formed to be slightly longer than a length of the light projection unit 3 in a short distance direction.

On the side surface of the microscope main body 1, an accommodation portion 122 for a light guide 24 is formed between the opening portion 120 and a microscope main body rear surface 121. The accommodation portion 122 is formed to have a width and a depth which enable accommodation of a light guide 24. The accommodation portion 122 arranges the light guide 24 disposed to a light guide attachment portion 85. It is to be noted that a light source 23 of the light guide 24 is provided outside the microscope main body 1.

FIG. 13 shows an A-A cross-sectional view of the accommodation portion 122. A tabular light guide holding member 123 is provided in the vicinity of the accommodation portion 122. The light guide holding member 123 may be formed in such a manner that an end thereof is slightly raised so that it can be caught by fingers of an operator.

A fitting portion 124 is provided to the micro-scope main body 1. The light guide holding member 123 is held on the side surface of the microscope main body 1 by a stepped shaft 125 which is fitted in the fitting portion 124. The light guide holding member 123 has, e.g., a coned disc spring 126 provided between itself and the microscope main body 1. The coned disc spring 126 gives an elasticity to the microscope main body 1 side. As a result, the light guide 24 is pressed by the elasticity of the coned disc spring 126 and does not readily rotate with respect to the microscope side surface 1.

An effect of the microscope having the above-described configuration will now be explained.

The light projection unit 3 is attached to the microscope main body 1. The light guide 24 is disposed to the light guide attachment portion 85 of the light projection unit 3. The light guide 24 which connects the light guide attachment portion 85 with the light source 23 is arranged in the accommodation portion 122 provided on the side surface of the microscope main body 1.

The light guide holding member 123 holds the light guide 24 at a position where the light guide holding member 123 does not rest on the accommodation portion 122 so that the light guide 24 can be readily arranged in the accommodation portion 122.

When the light guide 24 is arranged in the accommodation portion 122, the light guide holding member 123 is rotated in such a manner that the light guide holding member lies in the accommodation portion 122. As a result, the light guide 24 is accommodated without falling off the microscope main body 1.

When removing the light guide 24, the light guide holding member 123 is rotated. As a result, the light guide 24 can be readily removed from the accommodation portion 122.

It is to be noted that one light guide holding member 123 alone is provided but the plurality of light guide holding members 123 may be provided.

As described above, according to the fourth embodiment, the accommodation portion 122 is formed on the side surface of the microscope main body 1, and the light guide 24 is accommodated in the accommodation portion 122. Consequently, the peripheries of the apparatus do not become complicated. The operation in observation of the sample 10 is not obstructed, and the operability is excellent.

A fifth embodiment according to the present invention will now be described with reference to the accompanying drawings. It is to be noted that like reference numerals denote parts equal to those in FIG. 1, thereby eliminating the detailed explanation.

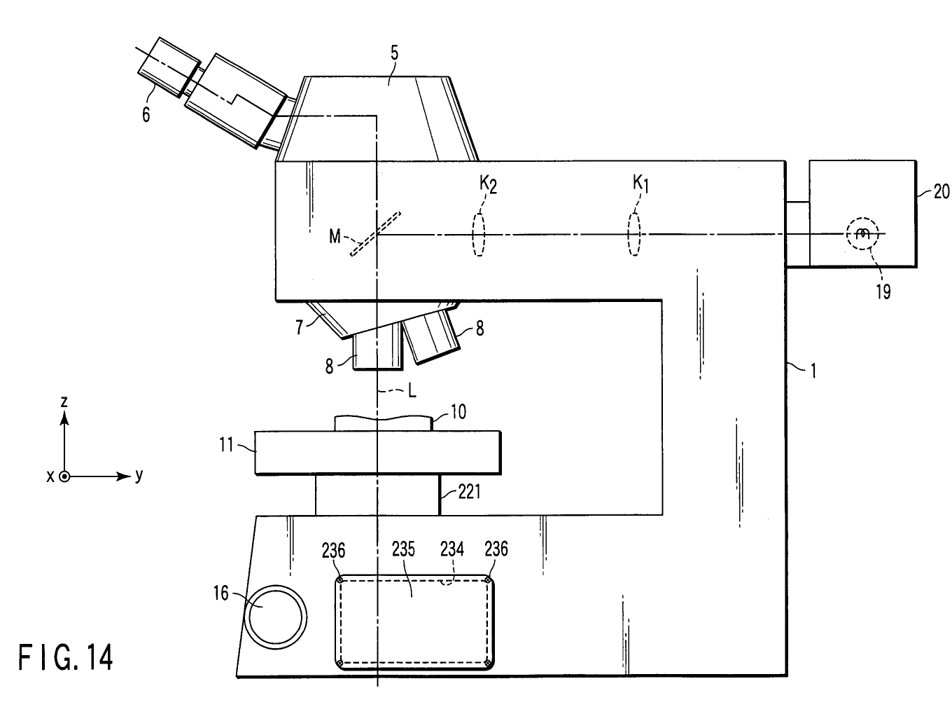

FIG. 14 shows a block diagram of a microscope. It is to be noted that an axis which is vertical to the observation optical axis L and exists on the right and left sides of the microscope main body 1 as seen from a user is determined as an X axis, an axis which is vertical to the observation optical axis L as seen from a user and exists on the front side and rear surface side of the microscope main body 1 is determined as a Y axis, and the observation optical axis L is determined as a Z axis for the convenience's sake.

A focus adjust devise 221 is provided to the lower portion of the microscope main body 1. A stage 11 on which a sample 10 such as a wafer is mounted is fixed to the focus adjust devise 221 by using, e.g., screws. The stage 11 can move in front/rear/right/left directions within a plane (an XY plane) vertical to the observation optical axis L as seen from a user. The focus adjust devise 221 moves up and down in response to a rotating operation of a focusing handle 16 provided on a side surface of the lower portion of the microscope main body 1.

A square opening portion 234 is provided on the side surface of the lower portion of the microscope main body 1. The opening portion 234 has a lid 235 fixed to the side surface of the microscope main body 1 by each screw 236.

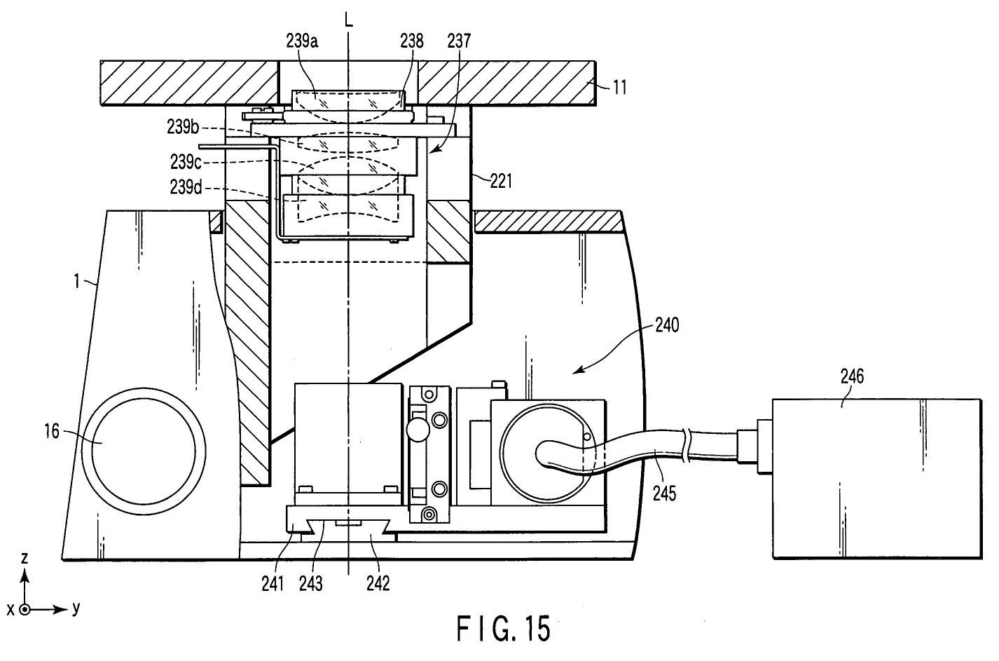

FIG. 15 shows a partial cross-sectional view of the inside of the lower portion of the microscope main body 1 as seen from the right side surface. The focus adjust devise 221 has a condenser lens unit 237 provided in a hollow portion formed into a cylindrical shape. The condenser lens unit 237 leads a transmitted illumination light to the sample 10. The condenser lens unit 237 holds respective optical elements 239a to 239d in a frame body 238 by using, e.g., an adhesive or a pressure ring. The condenser lens unit 237 fixes the respective optical elements 239a to 239d to the focus adjust devise 221 in such a manner that an axis of the optical elements 239a to 239d matches with the observation optical axis L. The condenser lens unit 237 is detachably provided to the focus adjust devise 221. It is to be noted that an elevating mechanism which moves up an down (a Z axis direction) an aperture diaphragm device or the respective optical elements 239a to 239d along the observation optical axis L is provided to the condenser lens unit 237.

A light projection unit 240 is accommodated in the lower portion of the microscope main body 1. The light projection unit 240 projects a light beam to the condenser lens unit 237. It is to be noted that the condenser lens unit 237 and the light projection unit 240 constitute a transmitted illumination unit.

The light projection unit 240 has a unit base 241. The unit base 241 is fitted in a dovetail portion 242 fixed on a bottom portion of the microscope main body 1 by screws or the like. The dovetail portion 242 is provided in parallel with the X axis direction. A dovetail portion 243 is provided in parallel with the X axis direction. The dovetail portion 242 and the dovetail portion 243 are engaged with each other and can move in the X axis direction.

The light projection unit 240 is inserted into the lower portion of the microscope main body 1 through the opening portion 234. The light projection unit 240 can be accommodated in the lower portion of the microscope main body 1 by engaging the dovetail portion 243 with the dovetail portion 242. The light projection unit 240 matches an axis of a later-described optical element 244 with the observation optical axis L and is fixed by non-illustrated screws or the like.

The light projection unit 240 can be removed to the outside of the microscope main body 1 through the opening portion 234 by releasing engagement of the dovetail portion 243 and the dovetail portion 242. Therefore, the opening portion 234 is formed in a size which enables insertion of the light projection unit 240.

A light guide 245 is disposed to the light projection unit 240. A light source 246 of a transmitted illumination apparatus is connected with the light guide 245.

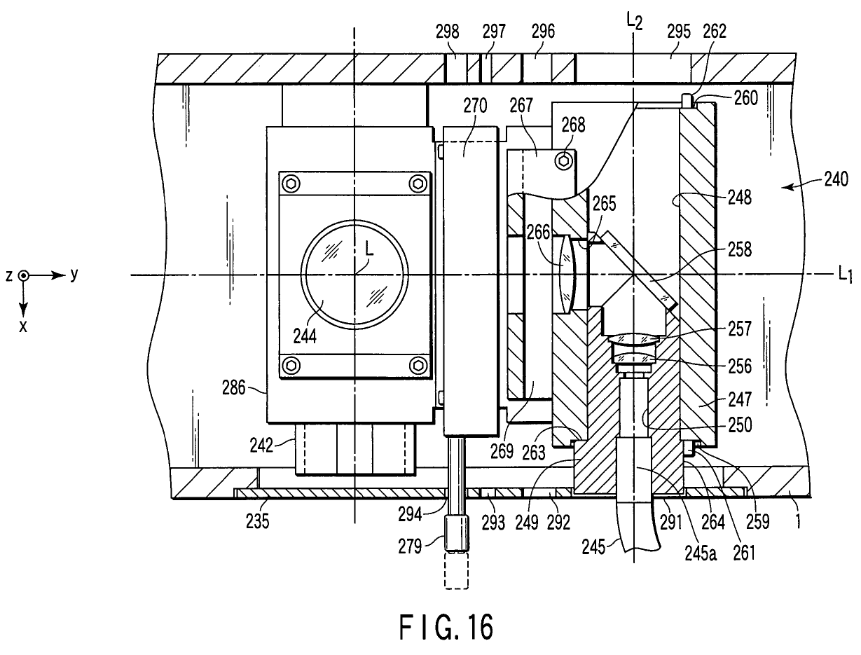

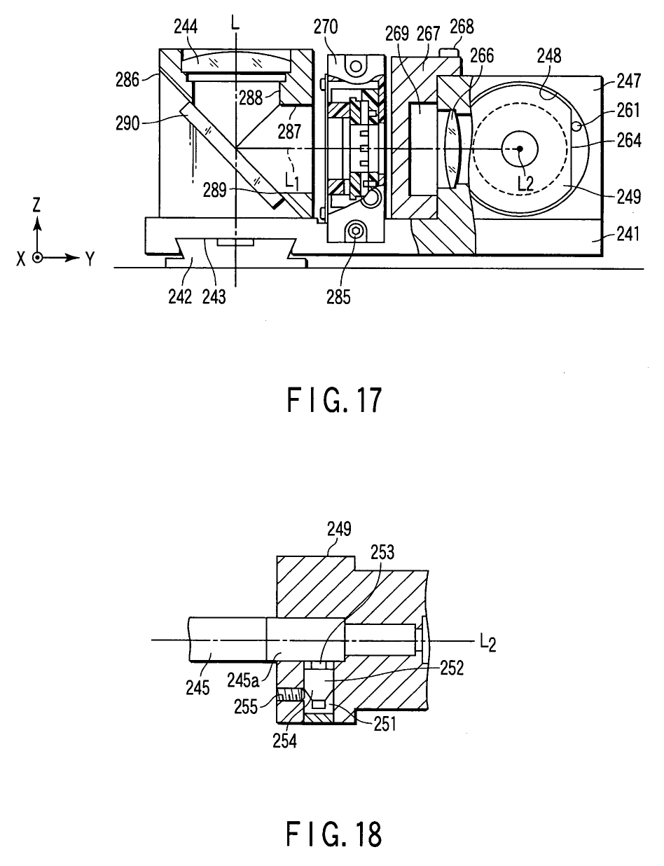

FIG. 16 shows a top view with a partial cross-sectional view of the light projection unit 240. FIG. 17 is a side view with a partial cross-sectional view of the light projection unit 240. A first frame body 247 having a longitudinal direction in the X axis direction is provided on the unit base 241. The first frame body 247 is formed to have a quadratic prism outer shape. A hollow fitting portion 248 piercing in the X axis direction is formed to the first frame body 247. It is to be noted that the fitting portion 248 is formed into a cylindrical shape.

An attachment member 249 is inserted into the fitting portion 248. The attachment member 249 attaches the light guide 245 to the light projection unit 240. The attachment member 249 is formed into a cylindrical shape which can be fitted in the fitting portion 248. A light guide insertion opening 250 is provided to the attachment portion 249 in such a manner that the light guide insertion opening 250 pierces through the inside of the attachment member 249. A light exit end portion 245a of the light guide 245 is inserted and fixed in the light guide insertion opening 250.

FIG. 18 shows a fixing mechanism for the light guide 245. A fixing hole 251 is provided in a direction vertical to the light guide insertion opening 250 and in the Z axis direction. A piece 252 is inserted in the fixing hole 251. A presser end portion 253 is formed to the piece 252 on one side, and a triangular pyramidal tapered surface 254 is formed to the same on the other end side. The presser end portion 253 presses the light guide 245.

A screw 255 is screwed in a direction vertical to the fixing hole 251. An end of the screw 255 is formed into hemisphere shape. The screw 255 can be screwed or loosened from the outside.

When such a fixing mechanism for the light guide 245 is adopted, the light guide 245 is inserted into the light guide insertion opening 250, and the screw 255 is screwed. The semicircular end of the screw 255 presses the tapered surface 254 of the piece 252. As a result, the piece 252 moves toward the light guide 245 side, and a side surface of the light guide 245 is pressed by the presser end portion 253. The light guide 245 is fixed in the light guide insertion opening 250.

On the other hand, when the screw 255 is loosened, the semicircular end of the screw 255 is moved apart from the tapered surface 254 of the piece 252. Since the fixing hole 251 is provided in the Z axis direction, i.e., the up-and-down direction, the piece 252 falls in a bottom portion of the fixing hole 251. Pressing of the light guide 245 by the piece 252 is released, and the light guide 245 is removed from the light guide insertion opening 250.

Respective optical elements 256 and 257 and a mirror 258 as a first deflection element are provided at the end portion of the attachment member 249. The mirror 258 is positioned on an optical axis L₁ vertical (the Y axis direction) to the observation optical axis L. The respective optical elements 256 and 257 and the mirror 258 are provided on an optical axis L₂ vertical (the X axis direction) to the optical axis L. The mirror 258 is provided at an angle of 45° with respect to the optical axis L₂. The respective optical elements 256 and 257 and the mirror 258 are held with respect to the attachment member 249 by, e.g., an adhesive or non-illustrated pressure rings or leaf springs.

Respective first attachment surfaces 259 and 260 are provided to both end surfaces of the first frame body 247. Each of the first attachment surfaces 258 and 260 positions the mirror 258 on the optical axis L. The respective first attachment surfaces 259 and 260 are provided in a concave shape at both end surfaces of the first frame body 247. Respective pins 261 and 262 are provided to the respective first attachment surfaces 259 and 260.

On the other hand, a second attachment surface 263 is provided on an outer peripheral surface of the attachment member 249. The second attachment surface 263 positions the mirror 258 on the optical axis L₁. The second attachment surface 263 is formed of a step protruding from the outer peripheral surface of the attachment member 49. A rotation restricting surface 264 is provided on the outer peripheral surface of the attachment member 249. The rotation restricting surface 264 is formed by notching the outer peripheral surface of the attachment member 249.

Therefore, when disposing the light guide 245 to the right side surface of the microscope main body 1, the attachment member 249 having the light guide 245 attached thereto is inserted into the fitting portion 248 from the right side of the microscope main body 1. The second attachment surface 263 of the attachment member 249 is brought into contact with one first attachment surface 259 of the first frame body 247. The pin 261 is brought into contact with the rotation restricting surface 264 of the attachment member 249.

As a result, the rotation restricting surface 264 of the attachment member 249 comes into contact with the pin 261. The attachment member 249 is restricted from rotating about an optical axis L₂. In this state, the attachment member 249 is fixed to the first frame body 247 by a non-illustrated screw or the like.

Consequently, the respective optical elements 256 and 257 and the mirror 258 are positioned on the optical axis L₂. The mirror 258 is positioned in such a manner that a reflection direction of a light beam exiting from the light guide 245 matches with the optical axis L₁.

On the other hand, when attaching the light guide 245 to the left side surface of the microscope main body 1, the attachment member 249 having the light guide 245 attached thereto is inserted into the fitting portion 248 from the left side, for example. The second attachment surface 263 of the attachment member 249 is brought into contact with the other first attachment surface 260 of the first frame body 247. The pin 262 is brought into contact with the rotation restricting surface 264 of the attachment member 249.

As a result, the rotation restricting surface 264 of the attachment member 249 comes into contact with the pin 262. The attachment member 249 is restricted from rotating about the optical axis L₂. In this state, the attachment member 249 is fixed to the first frame body 247 by non-illustrated screws or the like.

Consequently, positioning is performed in such a manner that a reflection direction of a light beam exiting from the light guide 245 becomes parallel with the optical axis L₁.

An attachment hole 265 is provided to the first frame body 247 on the optical axis L₁. An optical element 266 is provided in the attachment hole 265. The optical element 266 is held with respect to the first frame body 247 by, e.g., an adhesive or non-illustrated pressure rings or leaf springs.

A second frame body 267 is provided on the unit base 241 in contact with the first frame body 247. The second frame body 267 has a U-shaped cross section. The U-shaped opening side of the second frame body 267 is in contact with the first frame body 247, and fixed to the first frame body 247 by, e.g., a screw 268. It is to be noted that the second frame body 267 is provided on the surface of the first frame body 247 on the optical element 244 side. Consequently, a space of a slider insertion portion 269 is formed between the opening of the second frame body 267 and the first frame body 247.

The slider insertion portion 269 is formed in a direction vertical to the optical axis L₁. An optical element such as a polarizer or a filter held by, e.g., a non-illustrated slider frame can be inserted into or removed from the slider insertion portion 269 from the both right and left sides of the microscope main body 1.

Therefore, a width of the slider insertion portion 269 in the optical axis L₁ direction is formed to be substantially the same as a width of the slider frame. It is to be noted that a non-illustrated click mechanism such as a plunger or a leaf spring may be provided to the second frame body 267. As a result, the optical element such as a polarizer or a filter is locked at an appropriate position on the optical axis L₁.

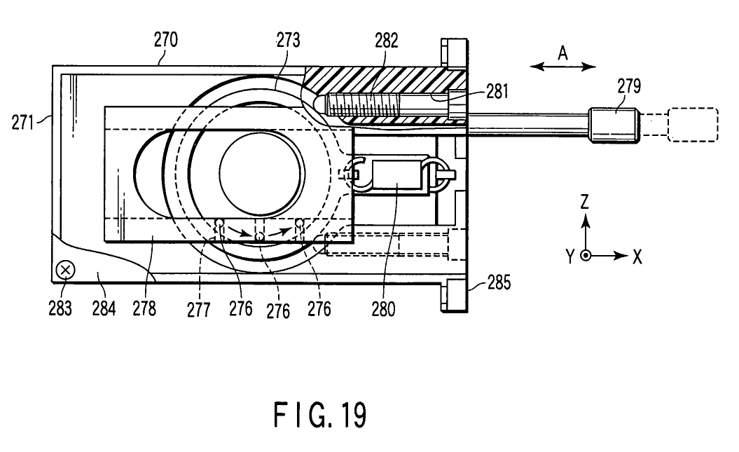

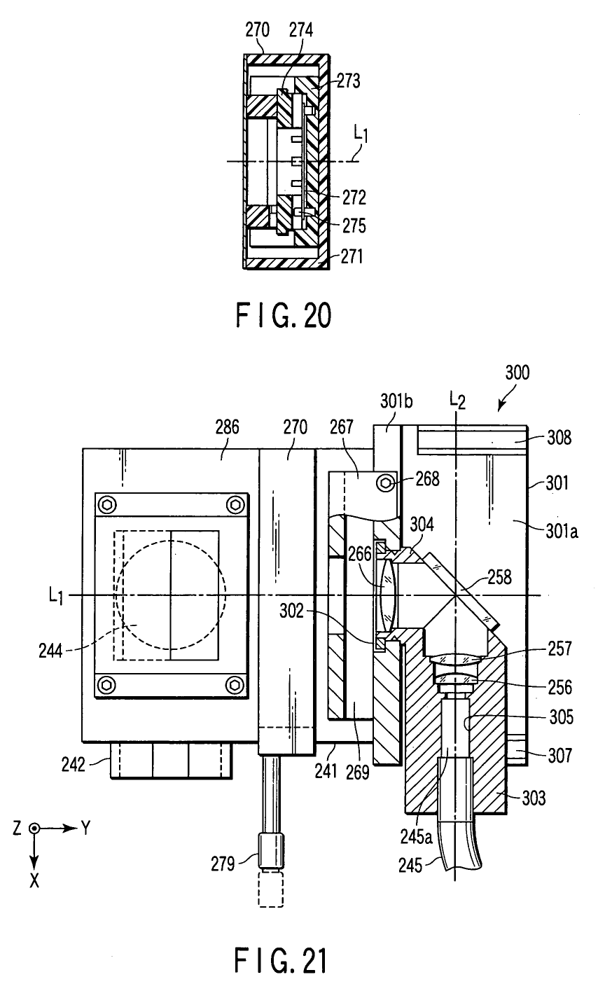

FIGS. 19 and 20 show block diagram of an aperture diaphragm device 270. FIG. 19 is a front view of the aperture diaphragm device 270. FIG. 20 shows a side view of the aperture diaphragm device 270. The aperture diaphragm device 270 is provided on the unit base 241 along the optical axis L₁. The aperture diaphragm device 270 has a box-like frame body 271. A plurality of aperture blades 272 are held with respect to two blade holding portions 273 and 274 by a pin 275 in the frame body 271. The blade holding portion 274 is rotatably provided with respect to the frame body 271. A pin 276 are provided to the blade holding portion 274.

A pin holding portion 277 is provided to a piece 278. The pin 276 is shut in by the pin holding portion 277 provided. As a result, when the piece 278 linearly moves in a longitudinal direction A, the pin holding portion 277 holding the pin 276 linearly moves in the longitudinal direction A. With this movement, the blade holding portion 274 rotates. An aperture diameter is adjusted by the rotating movement of the blade holding portion 274.

A knob 279 is provided to the piece 278 in such a manner that the knob 279 protrudes from the frame body 271. The knob 279 linearly moves the piece 278 in the longitudinal direction A. Therefore, when the knob 279 is pushed or pulled in the longitudinal direction A, the piece 278 linearly moves in the longitudinal direction A. It is to be noted that the aperture diaphragm device 270 shown in FIG. 16 is provided in such a manner that the knob 279 protrudes on the unit base 241, i.e., on the right side with respect to the light projection unit 240.

On the other hand, the blade holding portion 273 and the frame body 271 are coupled with each other by a spring 280. As a result, the blade holding portion 278 is pulled toward the upper right side in the drawing by an elasticity of the spring 280.

A screw hole 281 is provided to the frame body 271. A centering screw 282 having an end formed into a semispherical shape is screwed in the screw hole 281. When the centering screw 282 is screwed by, e.g., a non-illustrated tool, the centering screw 282 pushes in the blade holding portion 273 so that centering is enabled. The knob 279 and the centering screw 282 are provided in the same direction.

A cover plate 284 is fixed to the frame body 271 by a screw 283. As a result, the respective members such as the two blade holding portions 273 and 274, the plurality of aperture blades 272, the piece 278 and the like are shut in by the presser plate 284 and held in the frame body 271.

Such an aperture diaphragm device 270 is provided on the unit base 241 by screws 285 as shown in FIG. 17. Therefore, the aperture diaphragm device 270 can be attached or removed on the unit base 241, i.e., with respect to the light projection unit 240 by screwing or loosening the screws 285.

The aperture diaphragm device 270 can be attached on the unit base 241 in a state where the aperture diaphragm device 270 is rotated about the optical axis L1 by 180°. That is, aperture diaphragm device 270 can be attached on the unit base 241 in such a manner that the knob 279 protrudes on the left side of the light projection unit 240.

Therefore, when the aperture diaphragm device 270 is attached on the unit base 241 in such a manner that the knob 279 protrudes on the right side or the left side of the light projection unit 240, the aperture diaphragm device 270 is fixed on the unit base 241 by the screws 285 in such a manner that each aperture blade and the optical axis L₁ become vertical to each other. It is to be noted that the aperture diaphragm device 270 is provided at such a position that centering is enabled in the XZ plane and the center of an adjustment range in each of the X axis direction and the Z axis direction substantially matches with the optical axis L.

A frame body 286 is provided on the unit base 241. Respective cylindrical hollow portions 287 and 288 are provided in the frame body 286. The respective hollow portions 287 and 288 vertically cross each other. When the light projection unit 240 is provided in the microscope main body 1, the hollow portion 287 is provided on the optical axis L₁. The hollow portion 288 is formed in the frame body 286 in such a manner that it is provided on the observation optical axis L.

An inclined surface 289 is provided at an intersection of the respective hollow portions 287 and 288. The inclined surface 289 forms an angle of 45 degrees with respect to each of the optical axis L₁ and the observation optical axis L. A mirror 290 as a second deflection element is provided on the inclined surface 289.

An optical element 244 is provided in an opening portion of the hollow portion 288. The center of the optical element 244 matches with the observation optical axis L. The mirror 289 and the optical element 244 are held with respect to the frame body 286 by, e.g., an adhesive or non-illustrated fixing members or leaf springs.

A plurality of holes 291 to 294 are provided to the lid 235 as shown in FIG. 16. The attachment member 249 used for attaching the light guide 245 is inserted into or removed from the microscope main body 1 through the hole 291. A slider frame which holds an optical element such as a polarizer or a filter is inserted into or removed from the slider insertion portion 269 through the hole 292. The centering screw 282 of the aperture diaphragm device is operated through the hole 293. The knob 279 of the aperture diaphragm device 270 is caused to protrude toward the outside of the microscope main body 1 through the hole 294.

On the other hand, a plurality of holes 295 to 298 are likewise provided on a side surface (a left side surface) opposite to the side surface of the microscope main body 1 on which the lid 235 is attached. As to the respective holes 295 to 298, like the respective holes 291 to 294, the attachment member 249 which is used to attach the light guide 245 is inserted into or removed from the microscope main body 1 through the hole 295. The slider frame holding an optical element such as a polarizer or a filter is inserted into or removed from the slider insertion portion 269 through the hole 296. The centering screw 282 of the aperture diaphragm device is operated through the hole 297. The knob 279 of the aperture diaphragm device 270 is caused to protrude toward the outside of the microscope main body 1 through the hole 298.

An effect of the microscope having the above-described configuration will now be explained.

The lid 235 disposed to the lower portion of the microscope main body 1 is removed. The light projection unit 240 can be inserted into or removed from the inside of the lower portion of the microscope main body 1 through the opening portion 234 provided to the lower portion of the microscope main body 1.

When inserting the light projection unit 240 into the microscope main body 1, the light projection unit 240 is accommodated in the microscope main body 1 by engaging the dovetail portion 243 with the dovetail portion 242. The light projection unit 240 is fixed by non-illustrated screws or the like with an axis of the optical element 244 matching with the observation optical axis L.

The attachment member 249 which is used to attach the light guide 245, the slider frame which holds an optical element such as a polarizer or a filter in the slider insertion portion 269 and the knob 279 of the aperture diaphragm device 270 can be respectively inserted into or removed from the light projection unit 240 accommodated in the microscope main body 1 from the both right and left sides of the microscope main body 1. The operation of the centering screw 282 can be also enabled with respect to the light projection unit 240 accommodated in the microscope main body 1 from the both right and left sides of the microscope main body 1.

If the attachment direction of the light projection unit 240 shown in FIGS. 15 to 17 is adopted, the attachment member 249 which is used to attach the light guide 245 is fitted in the fitting portion 248 of the first frame body 247 through the hole 291 provided to the lid 235. The slider frame holding an optical element, e.g., a polarizer or a filter is inserted into or removed from the slider insertion portion 269 through the hole 292 provided to the lid 235. The knob 279 of the aperture diaphragm device 270 is caused to protrude toward the outside of the microscope main body 1 through the hole 294 provided to the lid 235.

On the other hand, the attachment member 249 which is used to attach the light guide 245 can be fitted in the fitting portion 248 of the first frame body 247 through the hole 295 provided on the left side surface of the microscope main body 1. The slider frame holding an optical element, e.g., a polarizer or a filter can be inserted into or removed from the slider insertion portion 269 through the hole 296 provided on the left side surface of the microscope main body 1.

The aperture diaphragm device 270 can be attached on the unit base 241 in a state where the aperture diaphragm device 270 is rotated about the optical axis L₁ by 180°, namely, in such a manner that the knob 279 protrudes on the left side of the light projection unit 240.

Therefore, the attachment member 249 which is used to attach the light guide 245 can be selectively disposed on one of the right and left side surfaces of the microscope main body 1.

The slider frame holding an optical element, e.g., a polarizer or a filter can be inserted into or removed from one of the right and left side surfaces of the microscope main body 1 in accordance with an application or the like in observation.

The aperture diaphragm device 270 can be attached in a state where the aperture diaphragm device 270 is rotated about the optical axis L₁ by 180°. A direction of operating a tool with respect to the knob 279 and the centering screw 282 can be fixed to one of the right and left side surfaces of the microscope main body 1.

Therefore, the knob 279 can be pushed in or pulled from the aperture diaphragm device 270 in a longitudinal direction A shown in FIG. 19 from one of the right and left side surfaces of the microscope main body 1. As a result, the blade holding portion 274 rotates, and a diameter of the plurality of aperture blades 272 can be adjusted. Since centering of the aperture diaphragm device 270 can be performed in the XZ plane, an adjustment can be effected to obtain an aperture diameter suitable for observation, and a position of the aperture diameter can be centered.

Transmitted illumination with respect to the sample 10 by the light projection unit 240 will now be described.

When a light beam is emitted from the light source 246, this light beam is led to the inside of the light projection unit 240 by the light guide 245. The light beam falls on the mirror 258 through the respective optical elements 256 and 257 provided at the light exit end portion 245a. The light beam is reflected toward the optical axis L₁ by the mirror 258 and falls on the mirror 290 through the optical element 266 and the aperture diaphragm device 270.

In this example, if the slider frame holding an optical element, e.g., a polarizer or a filter is inserted in the slider insertion portion 269, the light beam falls on the mirror 290 through the optical element such as a polarizer or a filter and the aperture diaphragm device 270.

The light beam is reflected toward the observation optical axis L by the mirror 290 and enters the condenser lens unit 237 through the optical element 244. The light beam is transmitted through the respective optical elements 239d, 239c, 239b and 239a of the condenser lens unit 237, and the sample 10 is illuminated with this light beam as a transmitted illumination light.

As described above, according to the fifth embodiment, the attachment member 249 having the light guide 245 attached thereto is fitted to the light projection unit 240 which can be accommodated in the microscope main body 1. The slider frame holding the optical element such as a polarizer or a filter is inserted into or removed from one of the right and left side surfaces of the microscope main body 1. The direction of operating a tool with respect to the knob 279 and the centering screw 282 of the aperture diaphragm device 270 can be fixed on one of the right and left lateral surface sides of the microscope main body 1.

As a result, the slider frame holding the optical element such as a polarizer or a filter or the aperture diaphragm device 270 can be accommodated in the microscope main body 1. A portion protruding from the microscope main body 1 can be eliminated. Nothing obstructs the operation or the like when observing the sample 10, e.g., the operation for activating the focusing handle 16 or the stage 11, thereby improving the operability.

A direction of attaching the light guide 245, a direction of inserting or removing the slider frame and a direction of operating the knob 279 and the centering screw 282 of the aperture diaphragm device 270 can be selected for one of the right and left side surfaces of the microscope main body 1 in accordance with an operation direction demanded by a user. For example, when any other device or the like exists on the left side of the microscope main body 1, the direction of attaching the light guide 245, the direction of inserting and removing the slider frame and the direction of operating the knob 279 and the centering screw 282 of the aperture diaphragm device 270 can be set on the right side of the microscope main body 1.

When the direction of attaching the light guide 245, the direction of inserting and removing the slider frame and the direction of operating the knob 279 and the centering screw 282 of the aperture diaphragm device 270 are set to an operation direction demanded by a user, the user can smoothly perform each operation.

The light projection unit 240 is accommodated in the microscope main body 1, and the lid 235 is closed. As a result, dust or dirt hardly adheres to the light projection unit 240, and the light projection unit 240 becomes superior in contamination control properties and can be protected from an impact shock or the like from the outside.

A sixth embodiment according to the present invention will now be described hereinafter with reference to the accompanying drawings. Like reference numerals denote parts equal to those in FIGS. 14 to 20, thereby eliminating the detailed description thereof.

FIG. 21 is a block diagram of a transmitted illumination unit of a microscope. A light projection unit 300 is provided with a first frame body 301. The first frame body 301 is provided on a unit base 241. The first frame body 301 is formed into an L-like shape. The first frame body 301 comprises a base body 301a and a support plate 301b which is erectly provided on a second frame body 267 side in the base body 301a. A second frame body 267 is fixed to the support plate 301b by a screw 268.

A rotation support hole 302 is provided to the support plate 301b. The rotation support hole 302 is formed into a circular shape with an optical axis L₁ at the center. A rotation frame 303 is supported in the rotation support hole 302 in such a manner that the rotation frame 303 can rotate about the optical axis L₁. The rotation frame 303 is an attachment member which is used to attach a light guide 245.

An end portion of the rotation frame 303 has a cylindrical rotation support frame 304. The rotation support frame 304 is provided to bend in a direction vertical to a longitudinal direction of the rotation frame 303. That is, the rotation frame 303 coincides with an optical axis L₂. The rotation support frame 304 coincides with an optical axis L₁. A light guide insertion opening 305 is provided to the rotation frame 303. Respective optical elements 256 and 257 and a mirror 258 as a first deflection element are provided at the end portion of the rotation frame 303.

The mirror 258 is positioned on the optical axis L₁. The respective optical elements 256 and 257 and the mirror 258 are provided on the optical axis L₂. The mirror 258 is provided to be vertical to a plane comprising the respective optical axes L₁ and L₂ and form an angle of 45° with each of the respective optical axes L₁ and L₂. The respective optical elements 256 and 257 and the mirror 258 are held with respect to the rotation frame 303 by, e.g., an adhesive or non-illustrated fixing members or leaf springs.

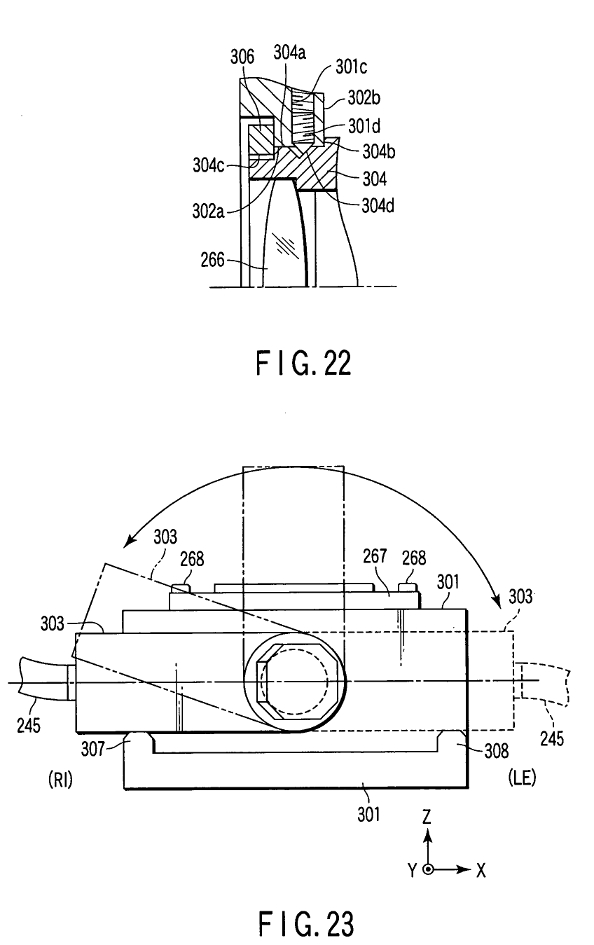

FIG. 22 shows a block diagram of rotation support of the rotation support frame 304 with respect to the rotation support hole 302. A fitting portion 302a is provided on an inner peripheral wall of the rotation support hole 302. A fitting portion 304a is provided on an outer peripheral wall of the rotation support frame 304. The fitting portion 302a and the fitting portion 304a are fitted to each other in surface.

A contact surface 302b is provided on the inner peripheral wall of the rotation support hole 302. A contact surface 304b having a step is provided on the outer peripheral wall of the rotation support frame 304. As a result, the rotation support frame 304 can be inserted toward the side which is parallel with the optical axis L1 and where an optical element 244 is provided in the rotation support hole 302. The rotation support frame 304 can be inserted until the contact surface 304b comes into contact with the contact surface 302b.

A screw portion 304c is provided on the outer peripheral surface of the rotation support frame 304. A fixing member 306 is screwed on the outer peripheral surface of the rotation support frame 304 through the screw portion 304c. The rotation support frame 304 is prevented from protruding toward the slider insertion portion 269 side by screwing the fixing member 306. Consequently, the rotation support frame 304 is supported so that the rotation support frame 304 can rotate about the optical axis L₁ in the rotation support hole 302.

A V-shaped groove 304d is provided on the outer peripheral surface of the rotation support frame 304. On the other hand, a screw hole 301c is provided in the support plate 301b. A screw 301d is screwed in the screw hole 301c.

Therefore, an end of the screw 301d is fitted in the V-shaped groove 304d by screwing the screw 301d. As a result, the rotation support frame 304 is fixed in the rotation support hole 302. It is to be noted that, when the end of the screw 301d is fitted in the V-shaped groove 304d, the end of the screw 301d does not match with the central position of the V-shaped groove 304d, and the rotation support frame 304 is fixed with the center of the V-shaped groove 304d slightly deviating from the end of the screw 301d to the fixing member 306 side.

It is to be noted that an optical element 266 is held in the rotation support frame 304 by, e.g., an adhesive or non-illustrated fixing members or leaf springs.

As shown in FIGS. 21 and 23, respective rotation restricting surfaces 307 and 308 are provided on both sides of the base body 301a in the first frame body 301. Each of the respective rotation restricting surfaces 307 and 308 restricts a rotation angle when the rotation frame 303 rotates about the optical axis L₁ with the inside of the rotation support hole 302 at the center.

That is, one rotation restricting surface 307 comes into contact with the rotation frame 303 and sets a direction of attaching the light guide 245 to the right side surface of the microscope main body 1. The other rotation restricting surface 308 comes into contact with the rotation frame 303 and sets the direction of attaching the light guide 245 to the left side surface of the microscope main body 1.

The effect of a microscope having the above-described configuration will now be explained.

When the screw 301d shown in FIG. 22 is loosened, the screw 301d comes off the V-shaped groove 304d. As a result, the rotation frame 303 which is used to attach the light guide 245 can rotate about the optical axis L₁ with the inside of the rotation support hole 302 at the center.

The rotation frame 303 is rotated about the optical axis L₁ in such a manner that the light guide 245 is attached on one of the left and right side surfaces LE and RI of the microscope main body 1 demanded by a user. For example, in cases where a user arranges the light guide 245 on the left side surface LE of the microscope main body 1, the rotation frame 303 is rotated about the optical axis L₁ until the rotation frame 303 comes into contact with one rotation restricting surface 308. On the contrary, in cases where a user attaches the light guide 245 on the right side surface RI of the microscope main body 1, the rotation frame 303 is rotated about the optical axis L₁ until the rotation frame 303 comes into contact with the other rotation restricting surface 307.

The rotation frame 303 is rotated about the rotation axis L₁ until the rotation frame 303 comes into contact with one rotation restricting surface 307 or the other rotation restricting surface 308. In this state, the screw 301d is screwed. At this time, the center of the V-shaped groove 304d deviates from the end of the screw 301d. As a result, the rotation support frame 304 is drawn toward the contact surface 304b side as shown in FIG. 22. Consequently, the rotation support frame 304 is fixed at an appropriate position.

A description will now be given as to transmitted illumination with respect to the sample 10 by the light projection unit 240.

A light beam emitted from the light source 246 is led to the inside of the light projection unit 240 by the light guide 245. The light beam falls on the mirror 258 through the respective optical elements 256 and 257 provided to the rotation frame 303. The light beam is reflected toward the optical axis L₁ by the mirror 258, and falls on the mirror 290 through the optical element 266 and the aperture diaphragm device 270.

In this example, if the slider frame holding an optical element such as a polarizer or a filter is inserted in the slider insertion portion 269, the light beam falls on the mirror 290 through the optical element such as a polarizer or a filter and the aperture diaphragm device 270. The light beam is reflected toward the observation optical axis L by the mirror 290, and enters the condenser lens unit 237. The condenser lens unit 237 illuminates the sample 10 with the light beam as a transmitted illumination light.

As described above, according to the sixth embodiment, the rotation frame 303 which is used to attach the light guide 245 is supported in such a manner that the rotation frame 303 can rotate about the optical axis L₁. As a result, the same advantage as that of the fifth embodiment can be demonstrated, and the direction of attaching the light guide 245 can be selected on either the left side or the right side of the microscope main body 1 demanded by a user by a simple operation of rotating the rotation frame 303.

Since the structure in which the rotation frame 303 is just rotated without removing the rotation frame 303 is adopted, the respective optical elements 256, 257 and 266 and the mirror 258 can be protected.

A seventh embodiment according to the present invention will now be described with reference to the accompanying drawings. It is to be noted that like reference numerals denote parts equal to those in FIGS. 14 to 21, thereby eliminating the detailed explanation of these parts.

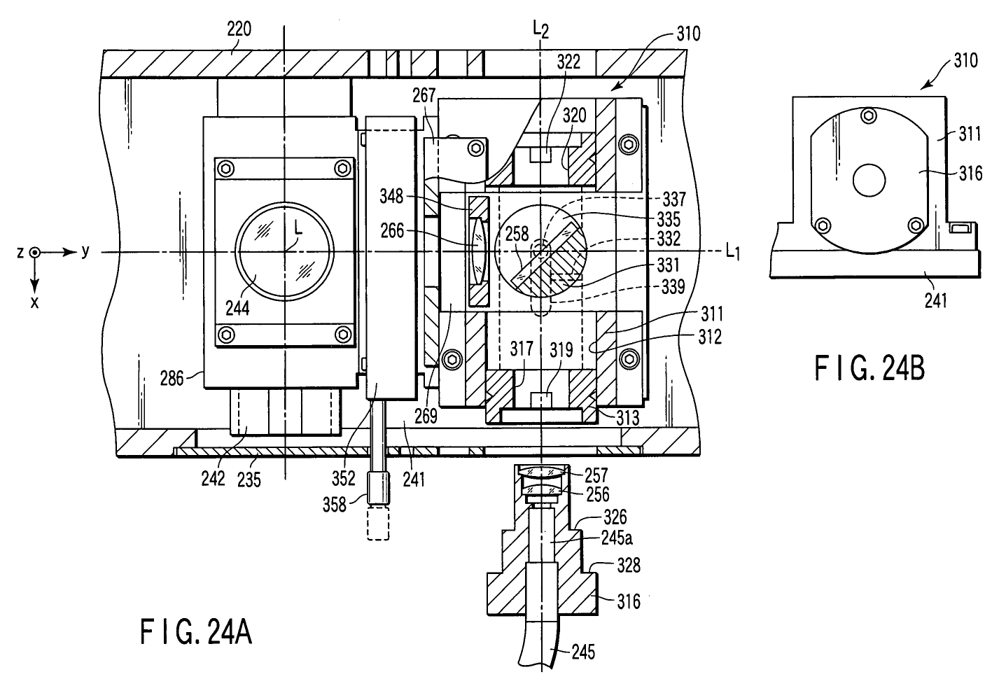

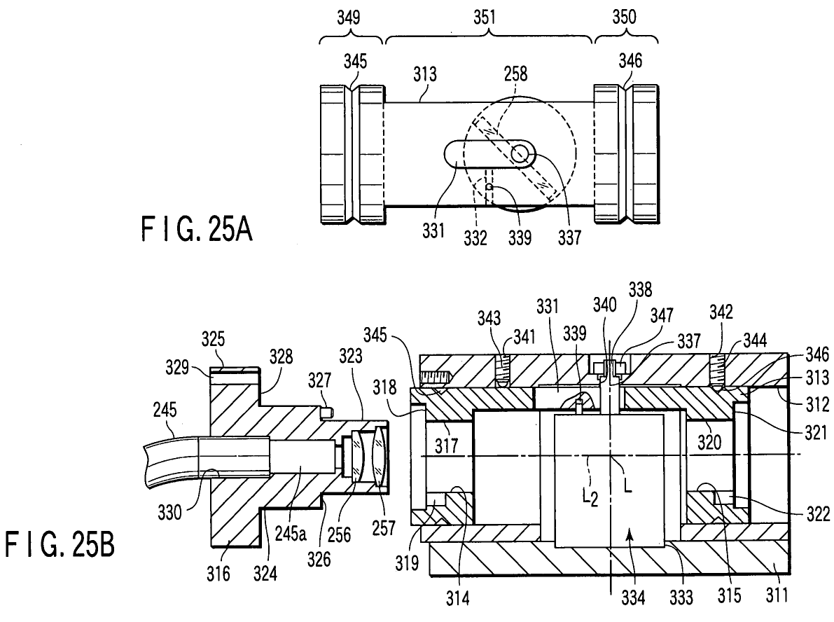

FIGS. 24A and 24B show block diagrams of a transmitted illumination unit of a microscope. FIG. 24A shows a top view of the transmitted illumination unit. FIG. 24B shows a partial side view of the transmitted illumination unit. FIGS. 25A and 25B show block diagrams of a part where a light guide 245 is attached. FIG. 25A shows a top view of a sliding member. FIG. 25B shows a side view of the sliding member.

A light projection unit 310 has a frame body 311 provided on the unit base 241. A hollow slide hole 312 is provided to the frame body 311 in a direction of an optical axis L₂. A cylindrical sliding member 313 is provided in the slide hole 312 in such a manner that the sliding member 313 can slide in a direction of the optical axis L₂. Respective fitting portions 314 and 315 are provided at both end portions of the sliding member 313. An attachment member 316 which is used to attach a light guide 245 is disposed to each of the fitting portions 314 and 315.

A fitting surface 317 and a contact surface 318 are provided to one fitting portion 314. An inner periphery of the fitting surface 317 is formed into a cylindrical shape. The contact surface 318 is formed outside the fitting surface 317, and an inner periphery of the contact surface 318 is formed into a circular shape. A notch portion 319 is provided at a predetermined part of the contact surface 318.

A fitting surface 320 and a contact surface 321 are provided to the other fitting portion 315 like the fitting portion 314. An inner periphery of the fitting surface 320 is formed into a cylindrical shape, for example. The contact surface 321 is formed outside the fitting surface 320, and an inner periphery of the contact surface 321 is formed into a circular shape. A notch portion 322 is provided at a predetermined part of the contact surface 321.

The attachment member 316 required to attach the light guide 245 has a hollow fitting portion 323, an intermediate cylinder 324 and a cylindrical attachment frame 325. The intermediate cylinder 324 has an outside diameter larger than an outside diameter of the fitting portion 323. The attachment frame 325 has an outside diameter larger than the intermediate cylinder 324.

A contact surface 326 is provided between the fitting portion 323 and the intermediate cylinder 324. A pin 327 is provided to the contact surface 326. An attachment surface 328 is provided between the intermediate cylinder 324 and the attachment frame 325. A screw hole 329 is provided to the attachment frame 325. A light guide insertion opening 330 is provided to the hollow portion of the attachment member 316. Respective optical elements 256 and 257 are provided at an end portion of the attachment member 316.

The attachment member 316 required to attach the light guide 245 can be attached to one fitting portion 314. When the fitting portion 323 of the attachment member 316 is inserted into the fitting surface 317, the contact surface 326 of the attachment member 316 is brought into contact with the contact surface 318 of the fitting portion 314. At this time, the pin 327 of the attachment member 316 enters the notch portion 319.

The attachment member 316 can be also attached to the other fitting portion 315. The fitting portion 323 of the attachment member 316 is inserted into the fitting surface 320. As a result, the contact surface 326 of the attachment member 316 is brought into contact with the contact surface 321 of the fitting portion 315. At this time, the pin 327 of the attachment member 316 enters the notch portion 322.

A long hole 331 is provided to an upper portion of the sliding member 313. The long hole 331 is provided along a sliding direction (the optical axis L₂) of the sliding member 313. A long groove 332 is provided to the upper portion of the sliding member 313. The long groove 332 is provided in a direction (the optical axis L₁) vertical to the longitudinal direction of the long hole 331.

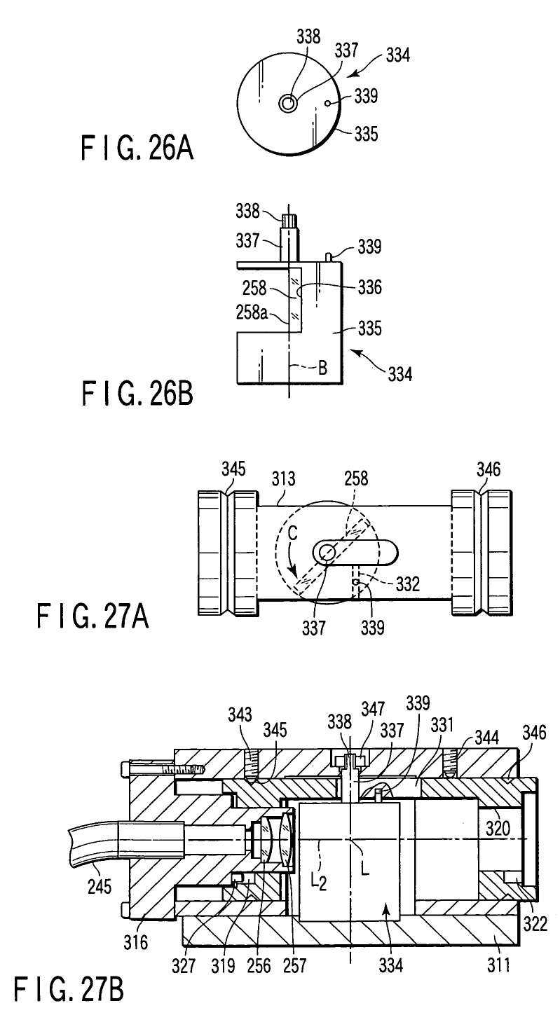

A circular fitting groove 333 is provided on a bottom surface of the frame body 311. A mirror holding portion 334 shown in FIGS. 26A and 26B is rotatably provided in the fitting groove 333. It is to be noted that FIG. 26A shows a top view of the mirror holding portion 334. FIG. 26B shows a side view of the mirror holding portion 334.

The mirror holding portion 334 has a cylindrical main body 335. A mirror attachment notch surface 336 is provided to the cylindrical main body 335. A mirror 258 is fixed to the notch surface 336 by, e.g., an adhesive or a non-illustrated leaf spring. When the mirror 258 is provided to the notch surface 336, a reflection surface 258a of the mirror 258 coincides with a rotation axis B.

A fitting shaft 337 is provided at the center of the upper surface of the mirror holding portion 334. The fitting shaft 337 is provided on the rotation axis B. A screw portion 338 is provided at an upper end portion of the fitting shaft 337. A pin 339 is provided on the upper surface of the mirror holding portion 334 at a part apart from the center.

A rotation support hole 340 and respective plunger screw portions 341 and 342 are provided to the upper portion of the frame body 311. Respective plungers 343 and 344 are provided in the respective plunger screw portions 341 and 342. Each of the plungers 343 and 344 has a hemisphere end portion. The respective plungers 343 and 344 are provided at respective positions symmetrical with the fitting shaft 337 of the mirror holding portion 334 at the center in a sliding direction of the sliding member 313.

Respective V-shaped grooves 345 and 346 are provided on the upper surface of the sliding member 313 corresponding to the respective positions of the respective plungers 343 and 344. One plunger 343 falls into and is locked in one V-shaped groove 345. The other plunger 344 falls into and is locked in the other V-shaped groove 346.

A fitting groove 333 is provided on the bottom surface of the frame body 311. The mirror holding portion 334 is rotatably provided in the fitting groove 333. The fitting shaft 337 of the mirror holding portion 334 is inserted into the rotation support hole 340 through the long hole 331. A fixing member 347 is screwed into the screw portion 338 of the fitting shaft 337 inserted in the rotation support hole 340.

As a result, the mirror holding portion 334 is rotatably supported in the fitting groove 333 and the rotation support hole 340. The pin 339 on the mirror holding portion 334 is movably inserted into the long groove 332 of the sliding member 313.

A lens frame 348 which holds the optical element 266 is provided on the slider insertion portion 269 side of the frame body 311. It is to be noted that the sliding member 313 is formed in such a manner that a width of an intermediate portion 351 between both end portions 349 and 350 is smaller than a width of each of the both end portions 349 and 350 having the respective fitting portions 314 and 315 provided thereto as shown in FIG. 25A. Consequently, even if the sliding member 313 slides in the direction of the optical axis L₂, the lens frame 348 and the sliding member 313 do not come into contact with each other.

Therefore, when attaching the attachment member 316 required to dispose the light guide 245 to one fitting portion 314, i.e., when disposing the light guide 245 on the right side surface of the microscope main body 1, the fitting portion 323 of the attachment member 316 is inserted into the fitting surface 317 from the direction shown in FIG. 25B as shown in this drawing, for example.

When the fitting portion 323 of the attachment member 316 is pushed into the fitting surface 317, the pin 327 comes into contact with the contact surface 318 of the sliding member 313, and the sliding member 313 is pushed. The locked state of the plunger 344 with respect to the V-shaped groove 346 is released by this pushing force.

Further, when the sliding member 313 is pushed toward the right side in FIG. 25B along the optical axis L₂, the mirror holding portion 334 having the pin 339 held in the long groove 332 of the sliding member 313 rotates in the fitting groove 333 and the rotation support hole 340 in accordance with the sliding movement of the sliding member 313 as shown in FIG. 27A. The mirror 258 rotates around the fitting shaft 337 in a direction indicated by an arrow C by rotation of the mirror holding portion 334.

When the sliding member 313 is further pushed, the plunger 343 falls into and is locked in the V-shaped groove 345 as shown in FIG. 27B. Consequently, the sliding movement of the sliding member 313 is stopped. Rotation of the mirror holding portion 334 is also stopped.

Thereafter, the attachment member 316 is rotated, and the pin 327 is moved to the notch portion 319. As a result, the contact surface 326 of the attachment member 316 comes into contact with and fixed to the contact surface 318. FIG. 24B shows a side surface when the attachment member 316 is attached and fixed to one fitting portion 314.

As a result, the mirror 258 is arranged so that a light beam from the light guide 245 inserted from the right side surface of the microscope main body 1 is reflected in a direction which coincides with the optical axis L₁.

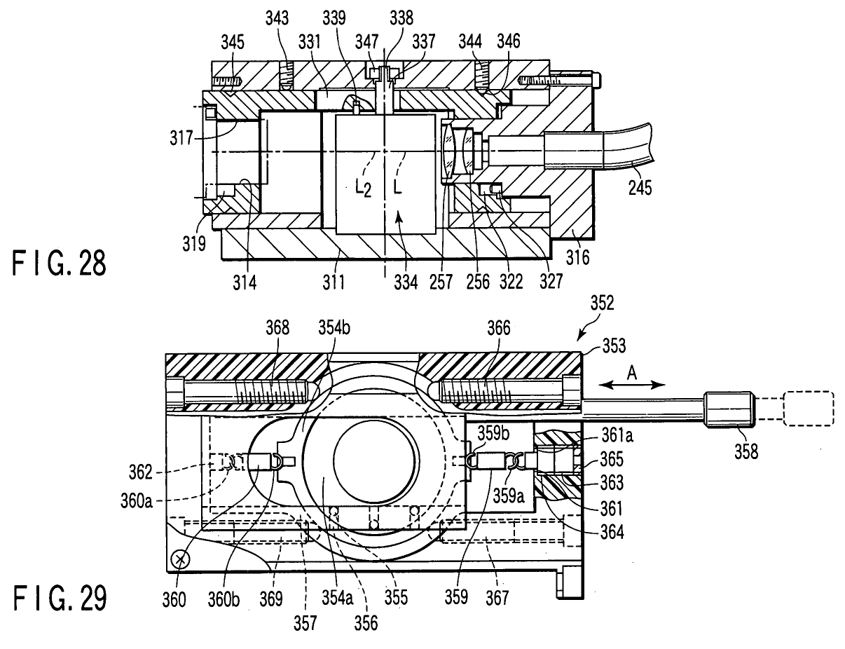

On the other hand, in cases where the attachment member 316 required to attach the light guide 245 is attached to the other fitting portion 315, i.e., where the light guide 245 is attached to the left side surface of the microscope main body 1, the fitting portion 323 of the attachment member 316 is inserted into the fitting surface 320 from a direction shown in FIG. 28 as shown in this drawing, for example.

When the fitting portion 323 of the attachment member 316 is pushed into the fitting surface 320, the pin 327 comes into contact with the contact surface 318 of the sliding member 313, and the sliding member 313 is pushed in. The locked state of the plunger 344 with respect to the V-shaped groove 346 is released by this pushing force.

When the sliding member 313 is further pushed toward the left side in FIG. 28 along the optical axis L₂, the mirror holding portion 334 having the pin 339 held in the long groove 332 of the sliding member 313 rotates in the fitting groove 333 and the rotation support hole 340 in accordance with the sliding movement of the sliding member 313. The mirror 258 rotates around the fitting shaft 337 in a direction opposite to the direction indicated by the arrow C by rotation of the mirror holding portion 334.

When the sliding member 313 is further pushed, the other plunger 344 falls into and is locked in the V-shaped groove 346 as shown in FIG. 28. As a result, the sliding movement of the sliding member 313 is stopped. Rotation of the mirror holding portion 334 is also stopped.

Thereafter, the attachment member 316 is rotated, and the pin 327 is moved to the notch portion 322. Consequently, the contact surface 326 of the attachment member 316 is brought into contact with and fixed to the contact surface 321.

As a result, the mirror 258 is arranged so that a light beam from the light guide 245 inserted from the left side surface of the microscope main body 1 is reflected in a direction which coincides with the optical axis L₁.

FIG. 29 shows a block diagram of an aperture diaphragm device 352. The aperture diaphragm device 352 is provided on the unit base 241. The aperture diaphragm device 352 has a box-like frame body 353. A plurality of aperture blades are held in respective blade holding portions 354a and 354b in the frame body 353. The blade holding portion 354a is rotatably provided with respect to the blade holding frame 354b. A pin 355 is provided to the blade holding portion 354a.

A pin holding portion 356 is provided to a piece 357. The pin 355 is shut in by a pin holding portion 356 provided to the piece 357. As a result, when the piece 357 linearly moves in the longitudinal direction A, the blade holding portion 354a rotates. An aperture diameter can be adjusted by rotation of the blade holding portion 354a.

A knob 358 which linearly moves the piece 357 in the longitudinal direction A is provided to the piece 357 in such a manner that the knob 358 protrudes from the frame body 353. Therefore, when the knob 358 is pushed or pulled in the longitudinal direction A, the piece 357 linearly moves in the longitudinal direction A.

Both ends of the blade holding portion 354a are coupled with each other through respective springs 359 and 360. The springs 359 and 360 respectively have hooks 359a, 359b, 360a and 360b at both ends thereof.

Respective screws 361 and 362 formed into a hook-like shape are provided on respective inner walls facing the respective springs 359 and 360 in the frame body 353. The screw 361 is caught by the hook 359a. The screw 362 is caught by the hook 360a.

The screw 361 is screwed in a screw hole 363 provided to the frame body 353. The screw 361 has a contact surface 361a. A contact ring 364 is provided to the screw hole 363. Therefore, the contact surface 361a of the screw 361 is brought into contact with the contact ring 364.

An annular fixing member 365 is screwed in the screw hole 363. The screw 361 can be screwed by inserting a tool through an open tubular hole of the fixing member 365.

It is to be noted that the screw 362 has the same configuration as the screw 361, but the description of the screw 362 is eliminated here.

Four respective screws 366 to 369 for centering are provided to the frame body 353. The respective centering screws 366 and 367 are provided to upper and lower portions of the frame body 353 on the right side. The respective centering screws 368 and 369 are provided to upper and lower portions of the frame body 353 on the left side. The respective centering screws 366 to 369 push the blade holding frame 354b and enable centering when screwed by, e.g., a non-illustrated tool.

When the screw 361 is screwed until the contact surface 361 is brought into contact with the contact ring 364, a length of the spring 359 becomes minimum. When the screw 362 is likewise screwed until a non-illustrated contact surface on the left side is brought into contact with the contact ring, a length of the spring 360 becomes minimum. At this time, tensile forces of the respective springs 359 and 360 are balanced and applied to the blade holding portion 354a.

In this state, a tool is inserted to the screw 361 through the fixing member 365, and the screw 361 is rotated by using this tool. When the screw 361 is drawn out until it comes into contact with the fixing member 365 by rotation of the screw 361, the spring 359 is pulled. When the spring 359 is pulled to increase the tensile force, the blade holding portion 354a is drawn toward the respective centering screws 366 and 367 on the right side.

Likewise, when the screw 362 is rotated and drawn out from a state where the tensile forces of the respective springs 359 and 360 are balanced, the blade holding portion 354a is drawn toward the respective centering screws 368 and 369 on the left side.

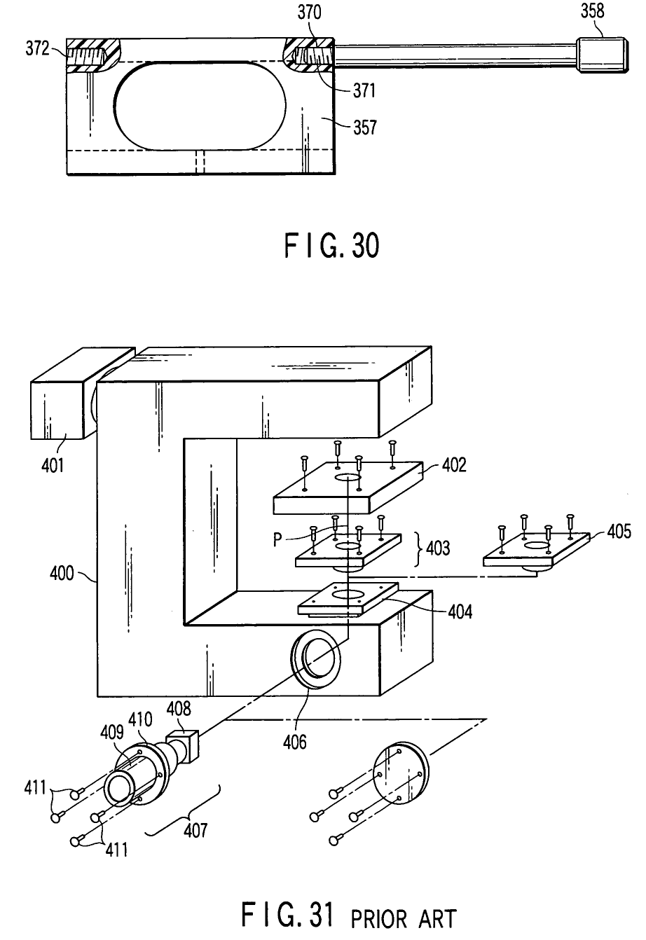

As shown in FIG. 30, a screw portion 370 is provided at an end portion of the knob 358. Respective screw holes 371 and 372 are provided at the both right and left end portions of the piece 357. As a result, the knob 358 can be screwed into the right and left screw holes 371 and 372 of the piece 357.

An effect of the microscope having the above-described configuration will now be described.

The light projection unit 310 is accommodated in the microscope main body 1 as shown in FIG. 24A. When attaching the light guide 245 on the right side surface of the microscope main body 1 in this state, the attachment member 316 required to attach the light guide 245 is attached to one fitting portion 314. In this attachment, the fitting portion 323 of the attachment member 316 is inserted into the fitting surface 317 from the direction shown in FIG. 25B as shown in this drawing.

When the fitting portion 323 of the attachment member 316 is pushed into the fitting surface 317, the pin 327 is brought into contact with the contact surface 318 of the sliding member 313, and the sliding member 313 is pushed in. The locked state of the plunger 344 with respect to the V-shaped groove 346 is released by this pushing force. When the sliding member 313 is further pushed toward the right side along the optical axis L₂, the mirror holding portion 334 holding the pin 339 in the long groove 332 of the sliding member 313 rotates in the fitting groove 333 and the rotation support hole 340 in accordance with the sliding movement of the sliding member 313 as shown in FIG. 27A. The mirror 258 rotates around the fitting shaft 337 in the direction indicated by the arrow C by rotation of the mirror holding portion 334. When the sliding member 313 is further pushed, the plunger 343 falls into and locked in the V-shaped groove 345 as shown in FIG. 27B. Consequently, the sliding movement of the sliding member 313 is stopped, and rotation of the mirror holding portion 334 is also stopped.

Thereafter, the pin 327 is moved to the notch portion 319 by rotating the attachment member 316. As a result, the contact surface 326 of the attachment member 316 is brought into contact with and fixed to the contact surface 318. The mirror 258 is arranged in such a manner that a light beam from the light guide 245 inserted from the right side surface of the microscope main body 1 can be reflected in a direction coinciding with the optical axis L₁.

On the other hand, when attaching the light guide 245 on the left side surface of the microscope main body 1, the fitting portion 323 of the attachment member 316 is inserted into the fitting surface 320 from a direction shown in FIG. 28 as shown in this drawing.

When the fitting portion 323 of the attachment member 316 is pushed into the fitting surface 320, the pin 327 is brought into contact with the contact surface 318 of the sliding member 313, and the sliding member 313 is pushed in. The locked state of the plunger 344 with respect to the V-shaped groove 346 is released by this pushing force. When the sliding member 313 is further pushed toward the left side in FIG. 28 along the optical axis L₂, the mirror holding portion 334 holding the pin 339 in the long groove 332 of the sliding member 313 rotates in the fitting groove 333 and the rotation support hole 340 in accordance with the sliding movement of the sliding member 313. The mirror 258 rotates around the fitting shaft 337 in a direction opposite to the direction indicated by the arrow C by rotation of the mirror holding portion 334. When the sliding member 313 is further pushed, the other plunger 344 falls into and locked in the V-shaped groove 346 as shown in FIG. 28. As a result, the sliding movement of the sliding member 313 is stopped, and rotation of the mirror holding portion 334 is also stopped.

Thereafter, the pin 327 is moved to the notch portion 322 by rotating the attachment member 316. As a result, the contact surface 326 of the attachment member 316 is brought into contact with and fixed to the contact surface 321. Consequently, the mirror 258 is arranged in such a manner that a light beam from the light guide 245 inserted from the left side surface of the microscope main body 1 is reflected in a direction coinciding with the optical axis L₁.

In the aperture diaphragm device 352, the respective springs 359 and 360 are provided at the both ends of the blade holding portion 354a. Consequently, the blade holding portion 354a is pulled toward the both sides and held by elasticity of the respective springs 359 and 360.

When performing centering from the respective centering screws 368 and 369 in the aperture diaphragm device 352, a tool is inserted to the screw 361 through the fixing member 365. The screw 361 is rotated and screwed by this tool until it is brought into contact with the contact ring 364. As a result, the tention of the respective springs 359 and 360 are weakened. The respective centering screws 366 and 367 are also loosened.

Here, the spring 360 which should be subjected to centering is pulled by the screw 362. Consequently, the blade holding frame 354b is pulled toward the respective centering screws 368 and 369. The blade holding portion 354a can perform centering in the respective screws 368 and 369 when pulled toward the respective centering screws 368 and 369.

On the other hand, when performing centering from the respective centering screws 366 and 367 in the aperture diaphragm device 352, a tool is inserted to the screw 362 through a non-illustrated fixing member on the left side of the microscope main body 1. The screw 362 is rotated and screwed by this tool until it is brought into contact with a non-illustrated contact ring. As a result, tention of the respective springs 359 and 360 are weakened. The respective centering screws 368 and 369 are also loosened.

Here, the spring 359 which should be subjected to centering is pulled by the screw 361. As a result, the blade holding portion 354a is drawn toward the respective centering screws 366 and 367. The blade holding portion 354a can perform centering in the respective screws 366 and 367 when drawn toward the respective centering screws 366 and 367.

A description will now be given as to transmitted illumination with respect to the sample 10 by the light projection unit 310.

A light beam emitted from the light source 246 is led to the inside of the light projection unit 310 by the light guide 245. The light beam falls on the mirror 258 through the respective optical elements 256 and 257 provided to the attachment member 316 of the light guide 245. The light beam is reflected toward the optical axis L₁ by the mirror 258, and falls on the mirror 290 through the optical element 266 and the aperture diaphragm device 352.

Here, if the slider frame holding an optical element such as a polarizer or a filter is inserted in the slider insertion portion 269, the light beam falls on the mirror 290 through the optical element such as a polarizer or a filter and the aperture diaphragm device 352.

The light beam is reflected toward the observation optical axis L by the mirror 290, and enters the condenser lens unit 237. The condenser lens unit 237 illuminates the sample 10 with the light beam as a transmitted illumination light.

As described above, according to the seventh embodiment, the sliding member 313 can be slidably provided in the frame body 313, and the attachment member 316 required to attach the light guide 245 can be inserted in the right or left side of the sliding member 313. The mirror holding portion 334 rotates in response to the sliding movement of the sliding member 313 caused due to the pushing force when the attachment member 316 is inserted in the right or left side of the sliding member 313.

As a result, the light projection unit 310 does not have to be removed out of the microscope main body 1. In a state where the light projection unit 310 is accommodated in the microscope main body 1, the attachment member 316 required to attach the light guide 245 can be attached on the right or left side surface of the microscope main body 1. Therefore, the direction of attaching the light guide 245 can be selected for the right or left side of the microscope main body 1 demanded by user by the sample operation.

The direction of inserting a centering tool can be changed to the right side or the left side without reattaching the aperture diaphragm device 352. Since the knob 358 which is used to move the piece 357 in the longitudinal direction can be attached/detached, the knob 358 can be inserted from the right side or the left side of the microscope main body 1 where the centering operation should be performed, thereby screwing the knob 358 to the piece 357. Therefore, the light projection unit 310 is not removed out of the microscope main body 1. The direction of operating the knob 358 and the centering screws 366 to 369 in the aperture diaphragm device 352 can be selected for the right side or the left side.

It is to be noted that the present invention is not restricted to the foregoing embodiments, and it may be modified as follows.

For example, although the light guide 24 is accommodated in the accommodation portion 122 provided on the side surface of the microscope main body 1, it may be arranged in the microscope main body 1 so that it can be led from a microscope main body rear surface 121.

How to accommodate the light guide 24 in the accommodation portion 122 or arrange the light guide 24 in the microscope main body 1 so that the light guide 24 can be led out from the microscope main body rear surface 121 can be applied to the first to third embodiments.

The present invention is not restricted to providing the dovetail portion 93 on the bottom surface of the light projection unit 3 and providing the dovetail portion 95 to the microscope main body 1, and the dovetail portion 95 may be provided on the bottom surface of the light projection unit 3 and the dovetail portion 93 may be provided to the microscope main body 1.

Although the fitting portion is formed at the end portion of the light projection unit 3, the present invention is not restricted thereto, the fitting portion may be formed at any position of the light projection unit 3 within a plane orthogonal to the optical axis of the light projection unit 3 as long as positioning of the light projection unit 3 can be carried out on the optical axis, for example.

Each light projection unit in the foregoing embodiments may be integrally formed by casting. That is, each of the light projection unit 3 shown in FIG. 4, the light projection unit 3 shown in FIGS. 6 and 7, the light projection unit 3 shown in FIGS. 9 and 10, the light projection unit 240 shown in FIG. 16, the light projection unit 300 shown in FIG. 21 and the light projection unit 310 shown in FIG. 24A may be integrally formed by casting.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. A microscope comprising:
an observation optical system which observe a image of a sample;
a microscope main body which has at least the observation optical system and has a stage on which the sample is mounted;
a light source which is provided outside the microscope main body and emits a light beam;
a light guide which transmits the light beam emitted from the light source;
a light projection unit which projects the light beam transmitted by the light guide;
a condenser lens unit which leads the light beam projected by the light projection unit to the sample mounted on an optical axis of the observation optical system; and
a light projection unit accommodating portion which has an opening portion provided to the microscope main body and detachably accommodates the light projection unit in the microscope main body through the opening portion.

2. The microscope according to claim 1, wherein the opening portion of the light projection unit accommodating portion is provided on a bottom surface of the microscope main body.

3. The microscope according to claim 1, wherein the opening portion of the light projection optical system accommodation portion is provided on a side surface of the microscope main body.

4. The microscope according to claim 1, wherein the light projection unit has at least one of a slider insertion/removal portion which inserts/removes various kinds of optical elements, a light guide attachment portion which attaches the light guide and a field stop device which performs field stop of the observation optical system.

5. The microscope according to claim 2, further comprising:
a fitting portion which is provided to the light projection unit and formed coaxially with an optical axis of the light projection unit; and
a fitting acceptance portion which is provided to the light projection accommodating portion unit and formed coaxially with the optical axis of the observation optical system,
wherein the fitting portion is removably fitted in the fitting acceptance portion, and the light projection unit is detachably accommodated in the microscope main body.

6. The microscope according to claim 3, further comprising:
a fixing member provided on one side surface of the light projection unit; and
a fixing acceptance member provided to the light projection unit accommodating portion,
wherein the fixing member is attached to the fixing acceptance member in order to accommodate the light projection unit in the microscope main body, and at least three surfaces of the fixing member are positioned to the fixing acceptance member as contact surfaces in order to position and accommodate the light projection unit in the microscope main body.

7. The microscope according to claim 1, further comprising:
a groove provided on the microscope main body side surface,
wherein the light guide is arranged in the groove.

8. A microscope comprising:
a microscope main body which has a stage on which a sample is mounted;
a light source which is provided outside the microscope main body and emits a light beam;
a light guide which leads the light beam emitted from the light source;
a light projection unit which projects the light beam led by the light guide;
a condenser lens unit which leads the light beam projected by the light projection unit to the sample as a transmitted illumination light; and
an attachment member to which a light beam exit end of the light guide configured to be attached,
wherein a fitting portion to/from which the attachment member configured to be attached/removed from each of right and left lateral surface sides of the microscope main body is provided to the light projection unit, and the light projection unit is provided in such a manner that the light projection unit configured to be accommodated in the microscope main body with the attachment member attached thereto.

9. The microscope according to claim 8, wherein a light guide insertion opening into which the light beam exit end of the light guide is inserted and which fixes the light beam exit end is provided to the attachment member.

10. The microscope according to claim 8, wherein the light projection unit has:
a first deflection element which deflects the light beam exiting from the light guide; and
a second deflection element which deflects the light beam deflected by the first deflection element toward the condenser lens unit.

11. The microscope according to claim 10, wherein a first attachment surface which positions the first deflection element is provided to the fitting portion,
a second attachment surface which positions the first deflection element is provided to the attachment member, and
the first deflection element is arranged on an optical axis along which the light beam from the sample side is reflected by the second deflection element by fixing the second attachment surface in contact with the first attachment surface.

12. The microscope according to claim 10, wherein a rotation axis of the attachment member having the light beam exit end of the light guide attached thereto is provided coaxially with an optical axis between the first deflection element and the second deflection element.

13. A microscope comprising:
a microscope main body which has a stage on which a sample is mounted;
a light source which is provided outside the microscope main body and emits a light beam;
a light guide which leads the light beam emitted from the light source;
a light projection unit which projects the light beam led by the light guide;
a condenser lens unit which leads the light beam projected by the light projection unit to the sample as a transmitted illumination light; and
an attachment member to which a light beam exit end of the light guide configured to be attached,
wherein the light projection unit is provided in such a manner that the light projection unit configured to be accommodated in the microscope main body, the attachment member is rotatably provided, and the light guide configured to be attached on a right or left side surface of the microscope main body by rotation of the attachment member.

14. The microscope according to claim 13, wherein a light guide insertion opening into which the light beam exit end of the light guide is inserted and which fixes the light beam exit end is provided to the attachment member.

15. The microscope according to claim 13, wherein the light projection unit has:
a first deflection element which deflects the light beam exiting from the light guide; and
a second deflection element which deflects the light beam deflected by the first deflection element toward the condenser lens unit.

16. The microscope according to claim 15, wherein a first attachment surface which positions the first deflection element is provided to the fitting portion,
a second attachment surface which positions the first deflection element is provided to the attachment member, and
the first deflection element is arranged on an optical axis along which the light beam from the sample side is reflected by the second deflection element by fixing the second attachment surface in contact with the first attachment surface.

17. The microscope according to claim 13, wherein the light projection unit has a rotation restricting surface which restricts rotation of the attachment member having the light beam exit end of the light guide attached thereto, restricts rotation of the attachment member by the rotation restricting surface, and attaches the light guide on the right or left side surface of the microscope main body.

18. The microscope according to claim 15, wherein a rotation shaft of the attachment member having the light beam exit end of the light guide attached thereto is coaxially provided with respect to an optical axis between the first deflection element and the second deflection element.

19. A microscope comprising:
a microscope main body which has a stage on which a sample is mounted;
a light source which is provided outside the microscope main body and emits a light beam;
a light guide which leads the light beam emitted from the light source;
a light projection unit which projects the light beam led by the light guide;
a condenser lens unit which leads the light beam projected by the light projection unit to the sample as a transmitted illumination light; and
an attachment member to which a light beam exit end of the light guide configured to be attached, the light projection unit having:
a first deflection element which deflects the light beam exiting from the light guide;
a second deflection element which deflects the light beam deflected by the first deflection element toward the condenser lens unit;
a mirror holding member which rotatably holds the first deflection element; and
a sliding member which enables attachment/detachment of the attachment member with respect to the light projection unit from a right or left side surface of the microscope main body, and slides in a direction vertical to an optical axis between the first deflection element and the second deflection element, thereby rotating the mirror holding member, the sliding member being provided in such a manner that it configured to be accommodated in the microscope main body.

20. The microscope according to claim 19, wherein a light guide insertion opening into which the light beam exit end of the light guide is inserted and which fixes the light beam exit end is provided to the attachment member.

21. The microscope according to claim 19, wherein a mechanism which rotates the mirror holding member has:
a rotation shaft provided to the mirror holding member;
a locking member provided to the mirror holding member;
a long hole which is provided to the sliding member in the same direction as a sliding direction of the sliding member and movably supports the rotation shaft; and
a long groove which is provided to the sliding member in a direction substantially vertical to the sliding direction of the sliding member and movably supports the locking member.

22. The microscope according to claim 19, having a slide restricting portion which restricts a slide of the sliding member when the attachment member having the light beam exit end of the light guide attached thereto is attached from the right or left side surface of the microscope main body, and restricts rotation of the mirror holding member at an angle with which an optical axis of the first deflection element coincides with an optical axis of the second deflection element.

23. The microscope according to claim 22, wherein the slide restricting portion has:
the respective right and left grooves provided to the sliding member; and
the respective right and left locking members which are locked in the respective grooves.

24. The microscope according to claim 19, wherein the rotation shaft of the mirror holding member is provided on the optical axis between the first deflection element and the second deflection element.
